(19) United States
(12) Patent Application Publication
(10) Pub. No.: US 2012/0050042 A1
(43) Pub. Date: Mar. 1, 2012

(54) ANTI-THEFT SECURITY DEVICE

(75) Inventors: Matthew R. Shute, Huntersville, NC (US); Adam Mark Will, Fort Mill, SC (US); William J. Kozlowski, JR., Tega Cay, SC (US)

(73) Assignee: CHECKPOINT SYSTEMS, INC., Philadelphia, PA (US)

(21) Appl. No.: 13/213,711

(22) Filed: Aug. 19, 2011

Related U.S. Application Data
(60) Provisional application No. 61/376,513, filed on Aug. 24, 2010.
(60) Provisional application No. 61/391,279, filed on Oct. 8, 2010.
(60) Provisional application No. 61/435,411, filed on Jan. 24, 2011.
(60) Provisional application No. 61/470,136, filed on Mar. 31, 2011.

(51) Int. Cl. G08B 13/14

(52) U.S. Cl. 340/572.1

(57) ABSTRACT

The invention relates to an anti-theft device primarily for securing articles of goods. In the preferred embodiment, a main housing of the device is secured to an article by way of a cable having two ends, whereby each end is inserted into the housing to form a loop around the article. Each end of the cable is secured to the housing by internally disposed locking nuts which allow the insertion of the end into the main housing, but prevent its removal. The device does not include a key or unlocking mechanism. A user must unscrew or cut the security device off the article once it is applied.

### CROSS-REFERENCE TO RELATED APPLICATIONS

This application claims priority from U.S. Provisional Application Ser. No. 61/376,513, filed Aug. 24, 2010; U.S. Provisional Application Ser. No. 61/391,279, filed Oct. 8, 2010; U.S. Provisional Application Ser. No. 61/435,411, filed Jan. 24, 2011; and U.S. Provisional Application Ser. No. 61/470,136, filed Mar. 31, 2011, the disclosures of which are incorporated herein by reference.

### BACKGROUND OF THE INVENTION

1. Technical Field

This invention relates to anti-theft security devices. More particularly, this invention relates to semi-permanently securing an anti-theft device having a security tag onto an article of goods to prevent theft. Specifically, this invention relates to extending a portion of the anti-theft device around an article of goods and securing the portion to a housing of the security device with a one-way lock mechanism to thereby firmly secure the anti-theft device to the article, whereby the anti-theft device may only be removed by unscrewing or cutting the anti-theft device off the article of goods.

2. Background Information

Heretofore, there have existed many product independent anti-theft devices intended to secure a wide range of commercial products. For example, electronic article surveillance (EAS) tags may be placed inside a box, adhered onto a product, or placed within the pages of book. To defeat the EAS tag, an individual would only have to remove it from the product. As a natural consequence, anti-theft devices have evolved to include devices which secure the EAS tag to the product while also protecting the tag from tampering and removal. These devices themselves must incorporate attachment mechanisms which are simultaneously difficult for a thief to remove, yet easy for a checkout clerk to remove. However, at present, anti-theft devices require a key or code to unlock the anti-theft device, adding significant complexity and time to the checkout process.

Heretofore, security devices have been constructed and assembled at a particular location, then shipped as fully assembled units to retail establishments to secure to the desired articles of goods. However, this method prevents security devices from being secured to goods within a shipping container or within the retail box with which the particular article is sold. As such, retail establishments must factor in the time it takes employees to secure the devices onto the goods, as well as the time it takes employees to remove the devices from the goods at checkout. This represents an enormous expenditure of time for every retail establishment.

For example, in recent years, hardware and home-improvement stores have seen an increase in thefts of threaded articles such as faucets which are commonly installed in a residential sink. This is due to the relatively small size of faucets coupled with their high value. Higher-end faucets typically cost several hundred dollars and are located on the sales floor so that customers may easily view and consider each shape, color, and style. Faucet boxes are small, light-weight cardboard which are easily opened and ripped apart. Therefore, placing an EAS tag inside the box or on the box itself is useless, as a thief would simply open or rip the box open and remove the EAS tag. However, home-improvement stores commonly carry hundreds of faucets which are sold in high volumes, and applying a more elaborate anti-theft device, such as a cable wrap device or using a security box would add substantial complexity to the storage and checkout of faucets. Therefore stores have not secured these products, as the cost and complexity to do so have generally outweighed the losses due to theft.

Therefore, a need in the art exists to incorporate a durable and inexpensive security device for attachment to an article of goods. The anti-theft device must be generally inexpensive, simple to use, and add minimal to no time to the checkout process. Furthermore, the anti-theft device should not require a key or specialized device for removal, and may be used in a disposable manner. The anti-theft security device should include minimal sub-components, such that the security device may be assembled by the manufacturer of a particular article at the point of manufacture so the anti-theft security device may be incorporated and attached to the article before packaging or boxing, and subsequent shipping the article to the retail store. Alternatively, the retail store could apply the security device before packaging such as shrink-wrap or boxing is applied. Thus, the security device should add minimal to no time to the retail store receiving process and in-store display process, as the security device is already attached and may even reside inside the box which contains the article. Furthermore, the security device should add minimal to no time to the retail store checkout process as the device is intended to be unscrewed or cut off the device, which doesn't require a key or a pass-code. It is intended that the purchaser may even remove and dispose of the device once purchased.

### BRIEF SUMMARY OF THE INVENTION

The present invention is an anti-theft security device which is configured to be secured to an article of goods, such as a faucet, cordless drill battery, golf club, or bottle. The preferred embodiment of the device includes a main housing which is comprised of a top portion and a bottom portion snap-fitted together to hold a plurality of locking nuts therein. Each locking nut is generally aligned with an internal channel which may receive an end of a cable. The cable is fixed in the housing at one end, or a middle portion, and the free end or ends are extended around the article. Thereafter the end or ends are fed into an internal channel within the main housing where the cable is permanently secured therein by the locking nuts. The user may then pull the end or ends of the cable through the housing to firmly secure the main housing and the cable to the article.

The security device may be removed by way of cutting the cable to release the main housing from the article of goods. The security device may also be removed by unscrewing or unwinding the device off of the article, if the overall shape of the article lends itself to this method of removal. Thus, the anti-theft security device is intended to primarily be a “one-time use” device which is discarded after use. It is intended that either the checkout clerk or the customer himself may remove this device by cutting, unscrewing, or unwinding it from the article of goods, either at the checkout counter or at the customer's house.

Another embodiment of the security device of the present invention incorporates a cable tie as the means for attachment to an article of goods. The cable tie is threaded through various apertures in the top portion and the bottom portion to allow a user to form a loop around the article, whereas the loop secures the security device to the article of goods.

Another embodiment of the security device of the present invention incorporates a housing which defines a top aperture and a bottom aperture, and includes a sliding member which acts to lock the security device onto the article when depressed. The sliding member includes components of a one-way snap-fit connection such that when the sliding member is depressed, internal camming elements prevent the sliding member from moving in an opposite direction, thereby locking the housing onto the article of goods.

All of the embodiments of anti-theft security device of the present invention include a security tag to prevent the unauthorized removal of the article from the store. The anti-theft device is intended to be applied either by the manufacturer or retail store personnel and reside on the article itself, possibly even within a box that the particular article of goods is sold within. The device may even be assembled by the manufacturer or retail store on site. Once the article is purchased, the anti-theft device may either be cut off or unscrewed off the article of goods by the store personnel or the purchaser. While a thief may also perform such removal within a store, it is generally understood that these acts would draw the attention of store personnel as it would take a significant amount of time and planning, particularly if the security tag is within the box that the article of goods is sold within.

### BRIEF DESCRIPTION OF THE SEVERAL VIEWS OF THE DRAWINGS

A preferred embodiment of the invention, illustrated of the best mode in which Applicant contemplates applying the principles, is set forth in the following description and is shown in the drawings and is particularly and distinctly pointed out and set forth in the appended claims.

FIG. 1 is a perspective view of the anti-theft security device of the present invention secured to an article;

FIG. 2 is an exploded view thereof;

FIG. 3 is a bottom plan view thereof;

FIG. 4 is a side elevational view thereof with a top portion spaced apart from a bottom portion;

FIG. 5 is a cross-sectional view taken along line 5-5 of FIG. 3;

FIG. 6 is a side elevational view of the top portion;

FIG. 7 is an enlarged view of FIG. 6;

FIG. 8 is a perspective view of a locking nut of the present invention;

FIG. 9 is a cross-sectional view of the present invention showing the cable in a cavity;

FIG. 10 is a partial cross-sectional view of one of the projections and projection receiving areas with a first end of the cable extended therethrough;

FIG. 11 is a view similar to FIG. 10 with the first end and the cable moved further in the direction of Arrow A;

FIG. 12 is a side elevational view of the anti-theft security device of the present invention secured to a cordless drill battery;

FIG. 13 is a side elevational view of the anti-theft security device of the present invention secured to a fishing pole;

FIG. 14 is a perspective view of another embodiment of the anti-theft security device of the present invention locked onto a threaded article by way of a cable tie;

FIG. 15 is an exploded view thereof;

FIG. 16 is a perspective view of a bottom portion of the embodiment of FIG. 14;

FIG. 17 is a bottom perspective view of the embodiment of FIG. 14;

FIG. 18 is a side plan view thereof with parts cut away;

FIG. 19 is a cross-sectional view thereof showing cable tie secured firmly to the article, and showing cable tie unsecured to the article in phantom;

FIG. 20 is a perspective view of another embodiment of the anti-theft device of the present invention locked onto an article with a flat area by way of a cable;

FIG. 21 is an exploded view thereof;

FIG. 22 is a bottom perspective view thereof;

FIG. 23 is a partial cross-sectional view thereof showing the cable tie secured firmly to the article;

FIG. 24 is a perspective view of another embodiment of the anti-theft security device of the present invention locked onto a threaded article;

FIG. 25 is a perspective view thereof;

FIG. 26 is an exploded view thereof;

FIG. 27 is a perspective view of a second housing member;

FIG. 28 is a cross-sectional view taken along line 28-28 of FIG. 25;

FIG. 29 is a cross-sectional view taken along line 29-29 of FIG. 25;

FIG. 30 is a top plan view thereof with parts removed showing the button in the first position and the device in the unlocked state;

FIG. 31 is a view similar to FIG. 30, showing the button in the second position and the device in the locked state;

FIG. 32 is a cross-sectional view of another embodiment of the present invention;

FIG. 33 is a cross-sectional view of another embodiment of the present invention in an unlocked state;

FIG. 34 is a bottom view of the embodiment of FIG. 33;

FIG. 35 is a cross-sectional view thereof and in a locked state;

FIG. 36 is a bottom view of the embodiment of FIG. 33; and

FIG. 37 is a diagrammatical view of a method of using the anti-theft device of the present invention to secure an article of goods.

Similar numbers refer to similar parts throughout the drawings.

### DETAILED DESCRIPTION OF THE INVENTION

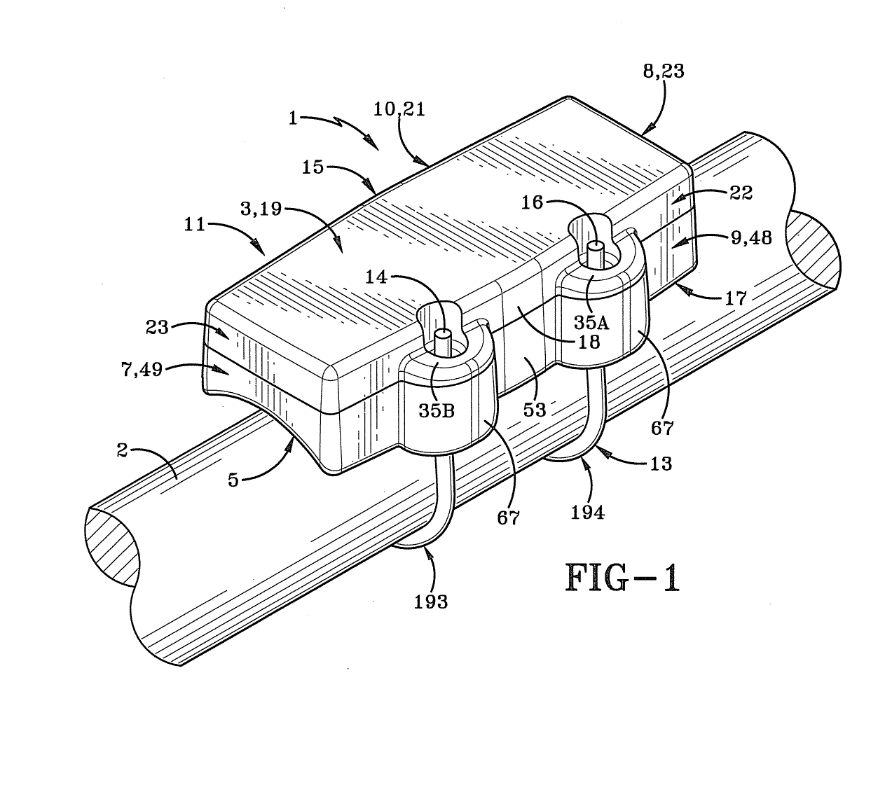

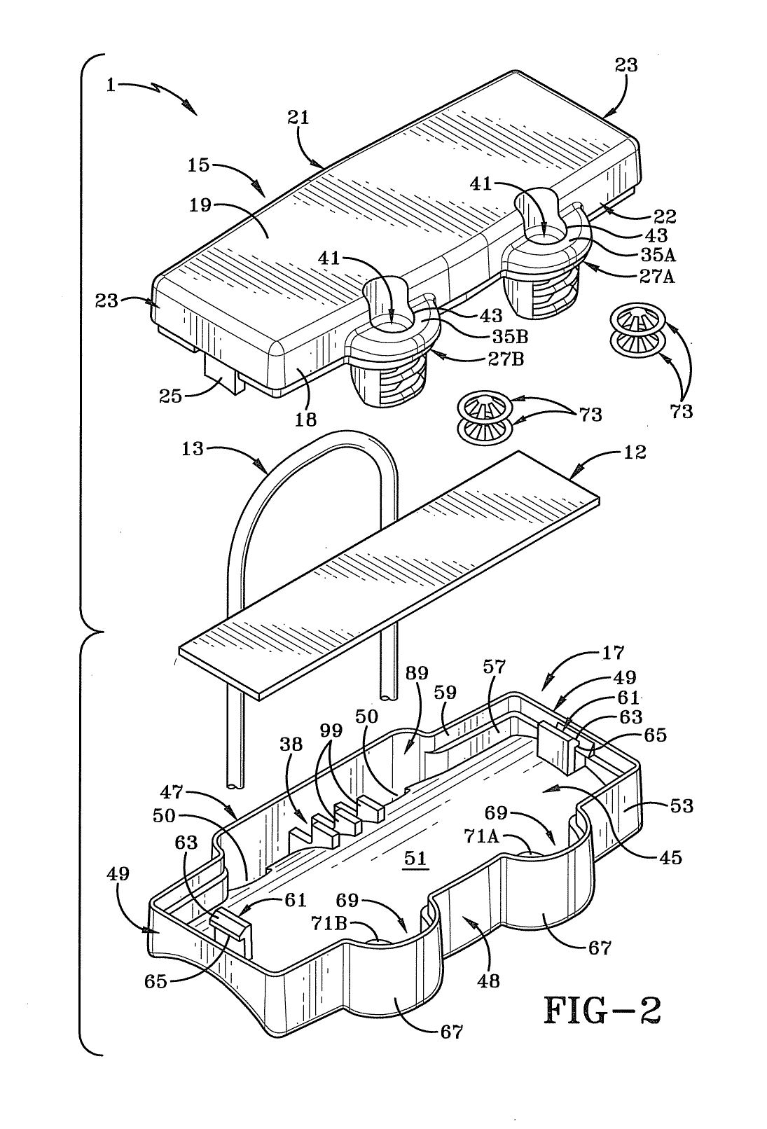

A first embodiment of a security device for securing articles of the present invention is shown in FIGS. 1-13 and is indicated generally at 1. As shown in FIG. 1, security device 1 is secured to an article 2, and is oriented to include a top 3, a bottom 5, a front end 7, a rear end 8, a first side 9, and a second side 10, wherein first side 9 and second side 10 extend generally between front end 7 and rear end 8. Security device 1 is broadly comprised of a main housing 11 and a length of cable 13. Main housing 11 includes a top portion 15 and a bottom portion 17, wherein a security tag 12 (FIG. 2) is disposed therebetween. Cable 13 is a single elongated cable extending from a first end 14 to a second end 16.

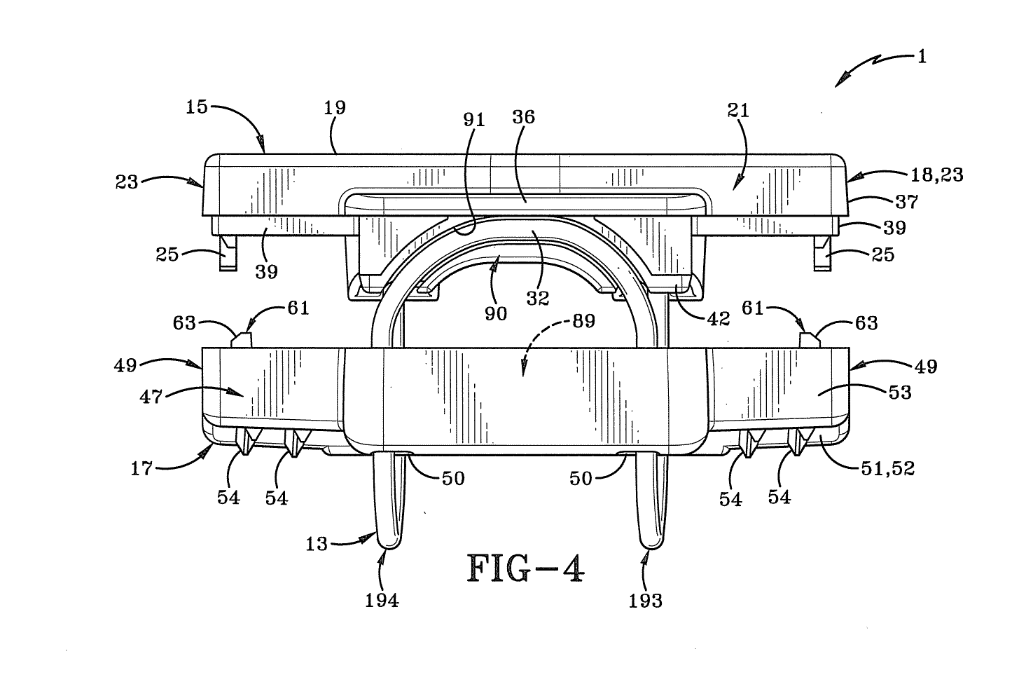

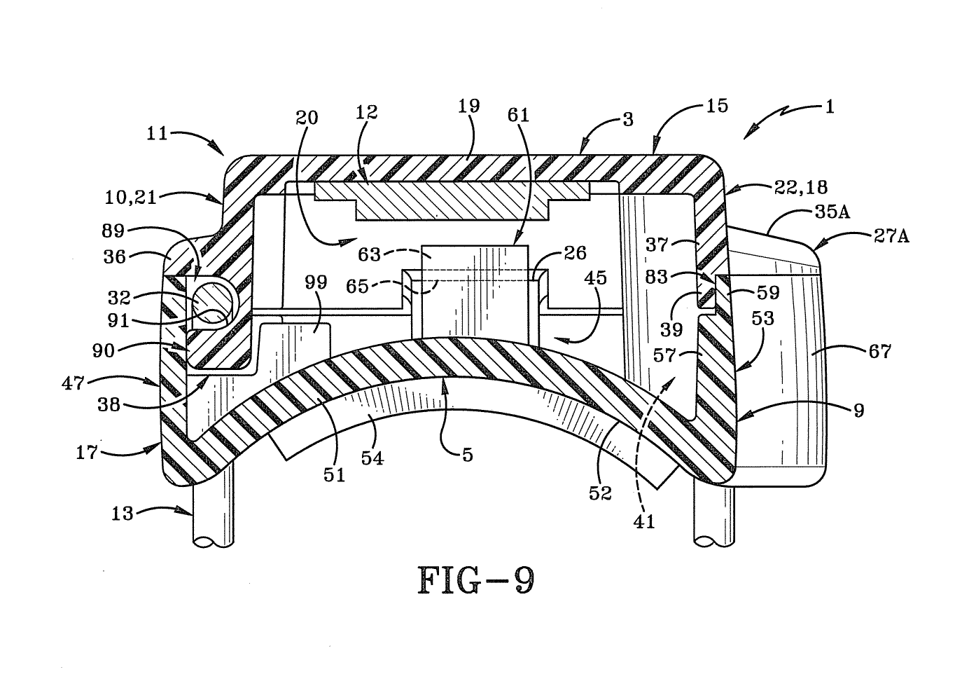

As shown in FIGS. 2, 4, and 9, top portion 15 of main housing 11 is an elongated open-top box-like structure which defines an inner cavity 20 (FIG. 9) and includes a first side 21 and a second side 22 spaced between a pair of ends 23. Top portion 15 further includes a back wall 19 and a sidewall 18 extending around the periphery of back wall 19. As shown in FIG. 9, sidewall 18 includes a main portion 37 and a recessed lip portion 39 in stepped orientation generally along the entire periphery of sidewall 18. As shown in FIG. 4, top portion 15 further includes a fastener receiver 25 located proximate each end 23, whereby each fastener receiver 25 is adjacent to sidewall 18 and is partially disposed in cavity 20 and partially extends outwardly therefrom. Each fastener receiver 25 includes a cam surface 26 disposed in cavity 20 (FIG. 9).

As shown in FIGS. 2 and 6, top portion 15 further includes a pair of projections 27 located proximate second side 22, whereby each projection 27 interrupts the generally straight and planer nature of sidewall 18 and extends outwardly away therefrom in a bowed out fashion. A corresponding cap area 35 is located generally proximate and above each projection 27, which acts to reinforce and brace the area where each projection 27 extends from sidewall 18 Inasmuch as security device 1 is intended to be resistant to unauthorized tampering, cap areas 35 further act to prevent unauthorized access to the interior regions of projections 27.

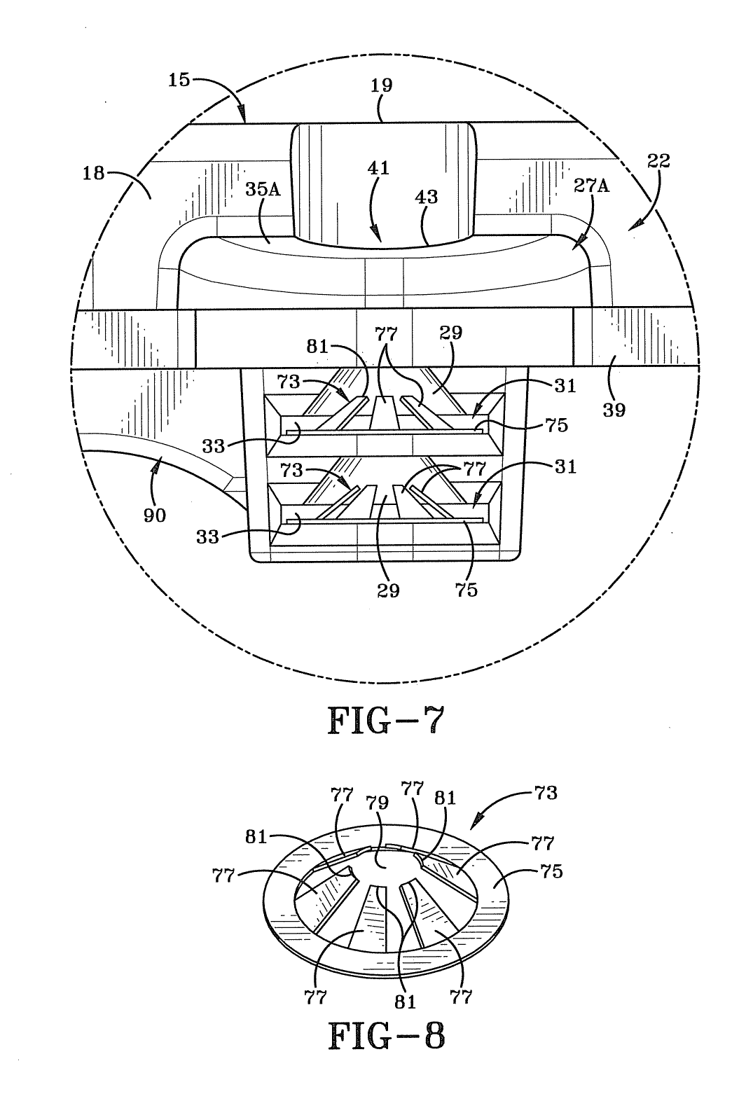

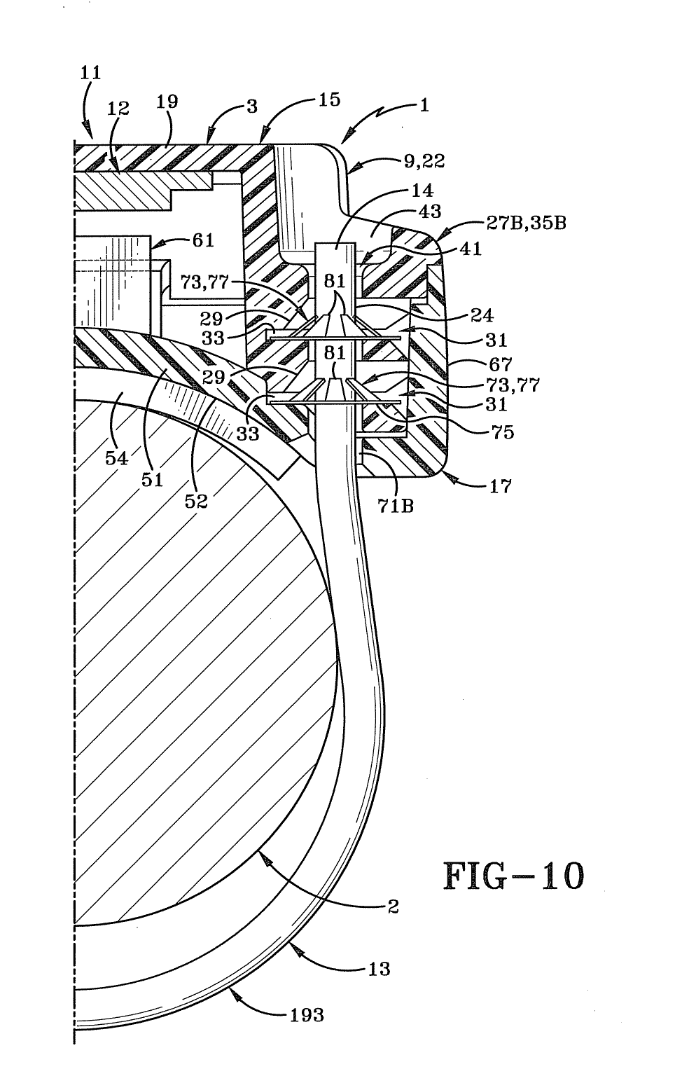

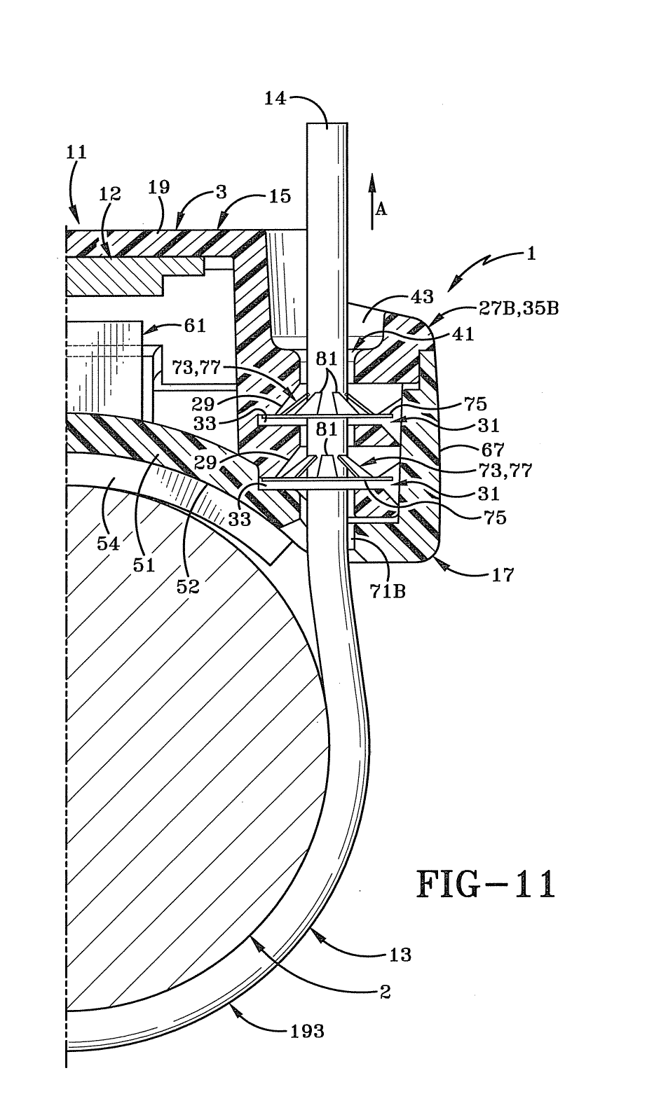

As shown in FIGS. 6 and 7, each projection 27 is formed in a generally cylindrical shape and includes a smooth semi-cylindrical back wall 29 disposed partially in cavity 20, and which extends outwardly beyond cavity 20. Each projection 27 further includes a pair of nut cavities 31 defined therein and oriented such that back wall 29 defines the closed back of each nut cavity 31 and an opening 33 in each nut cavity 29 is facing outwardly away from cavity 20. Each projection 27 defines an internal channel 41 (FIG. 10) for receiving a portion of cable 13 therethrough. As shown in FIGS. 6 and 7, each projection 27 further includes an opening 43 defined by cap area 35 for allowing a portion of cable 13 to extend outwardly away from internal channel 41, when a portion of cable 13 is disposed in internal channel 41.

As shown in FIG. 4, top portion 15 further includes a cable brace 90 located proximate first side 21, whereby cable brace 90 interrupts the generally straight and planer nature of sidewall 18 and extends downwardly away from cavity 20 to terminate in a lower end 42. Cable brace 90 defines an arcuate channel 91 disposed therein and existing in a generally concave C-shape with the midpoint of the C-shape proximate sidewall 18, and the end points of the C-shape distal from sidewall 18. As shown in FIG. 4, channel 91 is sized to receive and brace a midsection portion 32 of cable 13 therein. Similar to caps 35 disposed on each projection 27, a cap 36 is formed and disposed on cable brace 90 to protect unauthorized access to cable brace 90 and cable 13 when top portion 15 is secured to bottom portion 17.

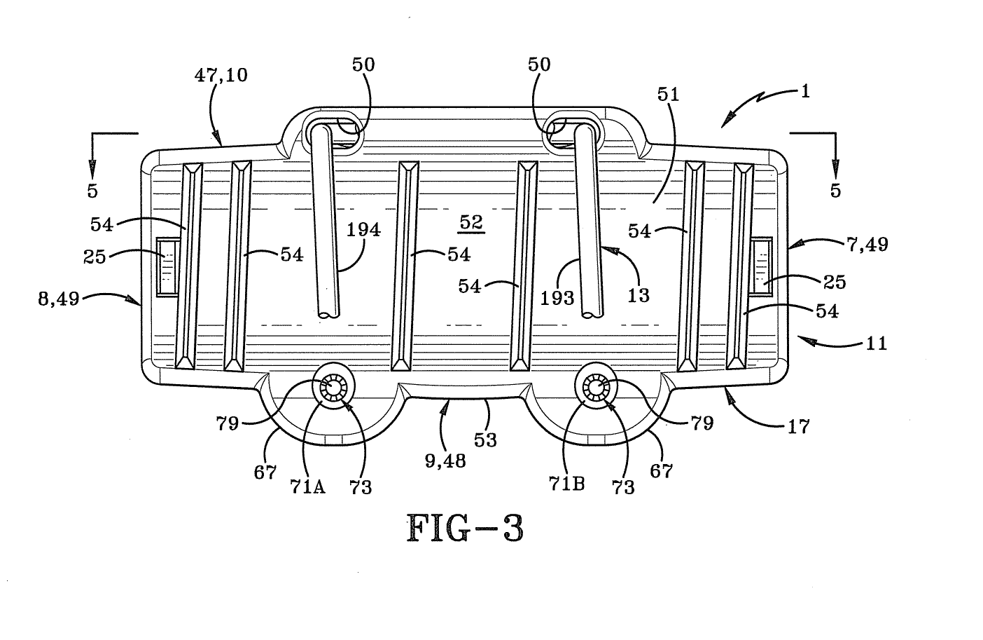

As shown particularly in FIGS. 2 and 3, bottom portion 17 of main housing 11 is an elongated box-like structure which defines an inner cavity 45 and includes a first side 47 and a second side 48 spaced between a pair of ends 49. As shown in FIG. 3, bottom portion 17 further includes a curved back wall 51 having an outer surface 52 with a plurality of fins 54 disposed thereon. While back wall 51 is shown as curved or arcuate, back wall 51 may be constructed to have any cross-sectional shape, and may be constructed to conform to a particular portion of article 2 or to form a complementary abutment between back wall 51 and a portion of article 2. Likewise, fins 54 may be formed in any general fin-like or thread-like shape, or any shape which is intended to provide or increase a sufficient frictional engagement with article 2.

As shown in FIG. 2, a sidewall 53 extends around the periphery of back wall 51 and includes a main portion 57 and a flange portion 59 in stepped orientation generally along the entire periphery of sidewall 53. Bottom portion 17 further includes a pair of fasteners 61 extending generally outwardly away from cavity 45 proximate each end 49 and having a cam surface 63 and a lock surface 65 disposed thereon.

The generally straight and planar nature of sidewall 53 is interrupted along second side 48 by a pair of bulge portions 67, whereby each bulge portion 67 defines a projection receiving area 69. Each projection receiving area 69 is configured to receive one of the pair of projections 27 therein, such that bulge portions 67 provide a protective covering to the corresponding projection 27 when top portion 15 is locked with bottom portion 17. As shown in FIGS. 3 and 10, each bulge portion 67 defines an opening 71, which is generally aligned with internal channel 41 of each projection 27 when top portion 15 and bottom portion 17 are locked together.

As shown in FIG. 2, bottom portion 17 further defines a receiving area 89 formed along sidewall 53 proximate first side 47. Receiving area 89 is sized and positioned to encase cable brace 90 therein when top portion 15 and bottom portion 17 are locked together and prevent unauthorized access to cable 13 and cable brace 90. Bottom portion 17 further defines a cavity 45 sized to receive lower portion 42 of cable brace 90 therein, and a pair of openings 50 (FIGS. 3 and 4) sized and positioned to allow cable 13 to extend therethrough. A plurality of stepped brace ribs 99 are formed within receiving area 89 and extend outwardly away from back wall 51 to form a seat 38. Lower portion 42 of cable brace 90 fits snuggly into seat 38 and is braced thereby when top portion 15 and bottom portion 17 are locked together. Thus, receiving area 89 acts to protect and stabilize cable brace 90 and midsection 32 of cable 13 when security device 1 is assembled and operable.

As shown in FIGS. 6-8, a plurality of locking nuts 73 are disposed in top portion 15, whereby each locking nut 73 is disposed in one of the nut cavities 31 in projections 27. As shown in FIG. 8, locking nut 73 includes a generally circular base 75 with a plurality of lock arms 77 extending inwardly therefrom to define a lock channel 79. Each lock arm 77 includes an outer surface 81 which is intended to abut a properly sized element placed in lock channel 79. Lock arms 77 are biased in a particular orientation relative to lock base 75 such that cable 13 placed therein may pass through lock channel 79 more easily in one direction. As shown in FIG. 10, nut cavities 31 are oriented such that lock arms 77 may freely extend towards top wall 15, yet prevent movement in the opposite direction beyond the general plane of base 75. Thus, it is a primary feature of the invention that locking nuts 73 allow movement of cable 13 in only one direction once cable 13 is disposed in lock channel 79. Locking nut 73 may be comprised of any material, however, is preferably comprised of a durable metallic material. Locking nut 73 may also be replaced by any one-way lock element which may be provided in a housing resembling housing 11 without departing from the spirit of the invention.

Top portion 15 and bottom portion 17 may be constructed or manufactured using any method commonly known in the art. However, these elements are preferably constructed using plastic or elastomeric material in an injection molding process. Furthermore, the overall shape of top portion 15 and bottom portion 17 may be altered or configured to better facilitate a complementary abutting relationship between security device 1 and article 2. Thus, if article 2 has a particular portion which better lends itself to an abutting relationship between security device 1 and article 2, the size and shape of top portion 15 and/or bottom portion 17 may be altered to realize this and complementarily conform to that particular portion.

Cable 13 is comprised of a generally durable material having sufficient strength to withstand the pulling, cutting, or tearing forces typically found in a retail environment when a thief is attempting to remove a security device. Optionally, cable 13 may be provided in bulk by way of an entire reel of cable or another bulk packaging manner, such that the user may cut an appropriate length of cable off to use when forming security device 1. The user may also cut multiple length of cable off the bulk reel for forming multiple security devices 1 in an assembly line fashion. As such, if the cable is provide in bulk form, the length of cable 13 may be interspersed with cut points or less sturdy areas where a user can more easily cut a length of cable. For example, cable 13 may include a durable wire interior portion along the length of cable 13. While this is beneficial in that such a cable 13 would be difficult for a thief to cut, such a cable 13 would also be difficult for a user and assembler to cut. As such, if cable 13 is provided in bulk, cable 13 may be supplied with portions which are free of the interior wire at spaced distances from one another to allow the user and assembler to cut through the wire at such portions.

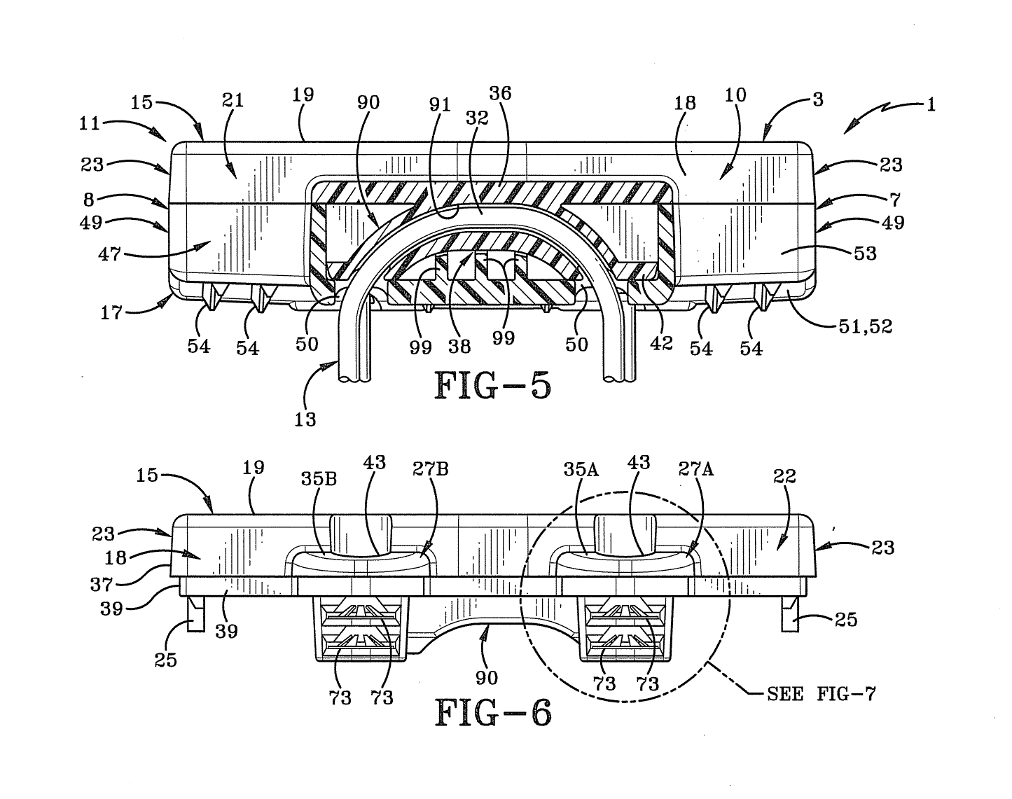

Once the individual elements comprising security device 1 are manufactured, security device 1 is assembled in the following manner. Security tag 12 is placed within cavity 20 of top portion 15. Midsection 32 of cable 13 is placed in channel 91 of cable brace 90 (FIG. 4) such that first end 14 and second end 16 of cable 13 freely extend away from top portion 15. Bottom portion 17 is then brought into proximity with top portion 15, and the user threads first end 14 and second end 16 through the corresponding and aligned opening 50 in bottom portion. Locking nuts 73 are placed in nut cavities 31 within each projection 27 through openings 33. This results in lock channels 79 being generally aligned with the corresponding internal channel 41 of projections 27. Top portion 15 is brought into closer proximity with bottom portion 17 such that projections 27 proximate side 21 of top portion 15 generally align with the corresponding projection-receiving areas 69 proximate side 47 of bottom portion 17. Projections 27 are thereby plunged into projection receiving area 69 such that cap area 35 abuts bulge 67, which disposes projections 27 inside main housing 11 of security device 1. Concurrently, as shown in FIG. 5, as top portion 15 is brought into abutment with bottom portion 17, cable brace 90 of top portion 15 is aligned with receiving area 89 of bottom portion 17. Thereafter, cable brace 90 is plunged into receiving area 89 such that lower portion 42 of cable brace 90 fits snuggly into seat 38 and is braced thereby. Cap 36 of cable brace 90 firmly abuts sidewall 53 proximate first side 47 to seal cable 13 in cavity 45 and presents a generally smooth and uninterrupted outer surface on housing 11.

In a snap-fit style connection, as top portion 15 is brought into abutment with bottom portion 17, cam surface 63 on fasteners 61 allows fasteners 61 to pass by fastener receiver 25. As top portion 15 is moved towards bottom portion 17, the biased nature of fasteners 61 moves lock surface 65 of fasteners 61 onto lock surface 26 of fastener receiver 25 thereby firmly connecting fastener 61 and fastener receiver 25. As understood in the art, once a snap-fit connection is made it is extremely difficult to disconnect top portion 15 from bottom portion 17. Thus, top portion 15 and bottom portion 17 are locked together and generally inseparable to form housing 11. First end 14 and second end 16 of cable 13 are thereafter pulled taught while midsection 32 of cable 13 remains disposed in channel 91 inside housing 11, such that no slack or extra cable 13 material exists within housing 11. In this fully assembled state, housing 11 contains midsection 32 and security tag 12 therein, and first end. 14 and second end 16 extend away from housing 11 such that first end 14 and second end 16 are free to wrap around an article as desired.

As shown in FIGS. 9 and 10, when top portion 15 is locked with bottom portion 17, main portion 37 and lip portion 39 of side wall 18 firmly abuts flange portion 59 of side wall 53, thereby creating an offset seal 83 entirely along the periphery of main housing 11. As shown in FIG. 7, offset seal 83 prevents the formation of a smooth and unencumbered entry into main housing 11, thereby preventing commonly used techniques for unauthorized removal of a security device from a protected article, such as prying with a screwdriver. As such, security device 1 is free from a direct linear route from the external areas of housing 11 to the internal areas of housing 11.

Security device 1 is intended to be secured to article 2, either by a retail store employee or a manufacturer at the point of manufacture for article 2. The four main components of security device 1: top portion 15, bottom portion 17, cable 13, and the plurality of locking nuts 73 may be supplied to the assembler as a kit, whereby the assembler assembles security device 1 on site using the methods discussed herein. Thus, it is a primary feature of the present invention that security device 1 is provided in a form that is easy to assemble, without the use of tools and with minimal parts, such that security device 1 may be assembled as needed or desired by the manufacturer or a retail store employee.

In operation, the user secures the assembled security device 1 onto article 2 in the following manner. Grasping device 1, the user applies outer surface 52 such that a portion of article 2 abuts bottom portion 17. If article 2 includes a disrupted area or a plurality of threads 87, the user positions fins 54 on outer surface 52 of bottom portion 17 to abut threads 87 on article 2. As discussed previously, fins 54 help to prevent sliding movement of housing 11 once security device 1 is firmly secured onto article 2. In the event that article 2 includes threads 87, fins 54 of security device 1 interlock or abut threads 87 of article 2 to present a significant impediment to sliding security device 1 off article 2.

Once security device 1 complementarily abuts article 2, first end 14 of cable 13 is wrapped around article 2 to form a first loop 193 around article 2. First end 14 is thereafter inserted through one of the openings 71 of bottom portion 17, as shown in FIGS. 3 and 10 and indicated as 71 B. When security device 1 is in the assembled state, opening 71 B is aligned with a corresponding internal channel 41 containing a plurality of locking nuts 73. In turn, lock channels 79 of locking nuts 73 are also aligned with opening 71 B. Thus, the user presses cable 13 in the direction of Arrow A (FIG. 11) to push first end 14 further through internal channel 41, thereby passing first end 14 through lock channel 79 of each locking nut 73 encountered therein. The biased and one-way locking nature of lock arms 77 on locking nuts 73 allow first end 14 to easily pass through lock channels 79 until cable 13 is sufficiently disposed therein. Moving cable 13, and particularly first end 14, in a direction opposite to Arrow A (FIG. 11) downwardly and outwardly through opening 71B is prevented by outer surfaces 81 on each lock arm 77 which firmly abut an outer surface 24 of cable 13 when moved in such a direction. Thus, lock arms 77 allow movement of first end 14 of cable 13 into and through internal channel 41 in the direction of Arrow A. Conversely, lock arms 77 prevent movement of cable 13 in a direction opposite Arrow A and out of internal channel 41 once first end 14 is disposed therein. Thus, as the user pushes first end 14 through internal channel 41, first end 14 of cable 13 becomes exposed through opening 43. The user can then pull first end 14 through opening 43 in the direction of Arrow A, tightening cable 13 and loop 193 around article 2 such that outer surface 24 of cable 13 firmly abuts article 2. The user then pulls cable 13 by first end 14 to cinch loop 193 and sufficiently tighten the abutment between security device 1 and article 2. As described herein, it is a primary feature of the invention that locking nuts 73 perform a one-way lock on first end 14, whereby the user can tighten the abutment between security device 1 and article 2 but the user cannot untighten this abutment due to lock arms 77.

In the same way first end 14 of cable 13 is locked inside internal channel 41A through an abutment with locking nuts 73, second end 16 is locked in the remaining internal channel 41 (FIG. 3) through an abutment with locking nuts 73. Specifically, second end 16 is wrapped around article 2 to form a second loop 194. Second end 16 is then passed through opening 71, as shown in FIG. 3 and indicated as opening 71A. Second end 16 is passed into and through corresponding internal channel 41 and thereafter extends outwardly away from opening 43. The user then pulls second end 16 to tighten second loop 194 around article 2. Thus, by creating two loops around article 2 the stability and the firm abutment between housing 11 and article 2 is increased along the entire length of housing 11. As shown in FIG. 1, first loop 193 tightens the abutment proximate front end 7 of security device 1, and second loop 194 tightens the abutment proximate back end 8 of security device 1. It has been found through extensive experimentation that two or more loops add a significant benefit over a single loop design. An additional loop around article 2 increases the difficulty of removing security device 1 from article 2, which increases the time required to perform such an act and correspondingly increases the theft-deterrent effect of security device 1 for a would-be thief.

Extensive experimentation and research on security device 1 has revealed that allowing first end 14 and second end 16 of cable to extend outwardly from openings 43 provides superior stability when compared to allowing first end 14 and/or second end 16 to remain within housing 11 and channel 41. As discussed previously, first end 14 and second end 16 are thrust entirely through inner channels 41 and out through openings 43. As such, locking nuts 73 within projections 27 can provide full support to cable 13 as locking nuts 73 are given more opportunity to bite on cable 13 as first end 14 and second end 16 pass therethrough. If first end 14 and/or second end 16 did not extend out of openings 43, the assembler would have no way of knowing if cable 13 has been extended through inner channel 41 sufficiently to engaged the uppermost locking nut 73 disposed therein. If the assembler does not sufficiently engage uppermost locking nut 73, security device 1 exists in a weakened state with no way to inspect for this defect. Thus, security device 1 provides improved structural stability when compared to other devices which require both ends of a cable loop to remain within the housing.

Once security device 1 is firmly secured to article 2 by way of cable 13, security device 1 cannot be easily removed therefrom. Any attempt to damage security device 1 through cutting, tearing, or pulling either main housing 11 or cable 13 is sufficiently prevented by the durable nature of security device 1 and the materials used therein. If a would-be thief attempts to pry open top portion 15 and bottom portion 17, offset seal 83 prevents the screwdriver or other device from penetrating far enough within main housing 11 to perform a prying motion successfully. Furthermore, the nature of cable 13 and locking nuts 73 are such that as the user applies a downward force on cable 13 or bottom portion 17, locking nuts 73 and lock arms 77 being disposed in top portion 15 ensure that top portion 15 follows this downward force along with bottom portion 17 and cable 13, thereby neutralizing such force with respect to opening security device 1. Furthermore, due to fins 54 of bottom portion 17, security device 1 is prevented from sliding off article 2, as fins 54 extend into any pockets, seams, or corresponding threads exposed on article 2. Thus, every simple or convenient way for removing security device 1 from article 2 has been sufficiently neutralized by the overall design of security device 1. As such, a thief is required to spend a sufficient amount of time trying to remove security device 1.

As shown in FIG. 3, fins 54 provide an angled member to frictionally engage any threads or seams that may be located on article 2. Fins 54 are angled such that an unwinding or unscrewing motion acts to transfer security device 1 down the shaft along the threads, if the particular article 2 sought to be protected includes such a structure. For example, a typical faucet (not shown) includes a faucet stud (not shown) which is an elongated threaded member. When security device 1 is secured to the faucet stud, fins 54 are disposed in the threads of the faucet stud. As such, security device 1 may be removed from the faucet by unwinding or unscrewing security device 1 off the faucet stud along the path of the threads.

It is a primary feature of this invention that security device 1 may only be removed from article 2 by way of cutting security device 1 off article 2, or unscrewing security device 1 off of article 2 if article 2 includes threads 87 which interact with fins 54. Security device 1 makes no distinction between a would-be thief cutting or unscrewing security device 1 or a downstream legal purchaser cutting or unscrewing security device 1 from article 2. However, performing the cutting and unscrewing operation is generally a time consuming process, which acts to deter would-be thieves from attempting such operation within the retail store. Inasmuch as security tag 12 is disposed in main housing 11, if security device 1 is not removed from article 2 within the retail establishment or demagnetized by store personnel, it will set off an audible alarm when passing through the exit. Thus, it is a primary feature of this invention that security device 1 is quasi-permanently attached to article 2 with respect to the time required to remove security device 1 from article 2 within the store. It is intended that a would-be thief would not have sufficient time to remove security device 1 in the store, nor will the thief be able to transport article 2 out of the store without actuating audible alarms due to security tag 12. As discussed previously, security tag 12 is disposed between top portion 15 and bottom portion 17 when top portion 15 and bottom portion 17 are locked together. It will be readily understood that any security tag or audible alarm anti-theft system may be used without departing from the spirit of the invention.

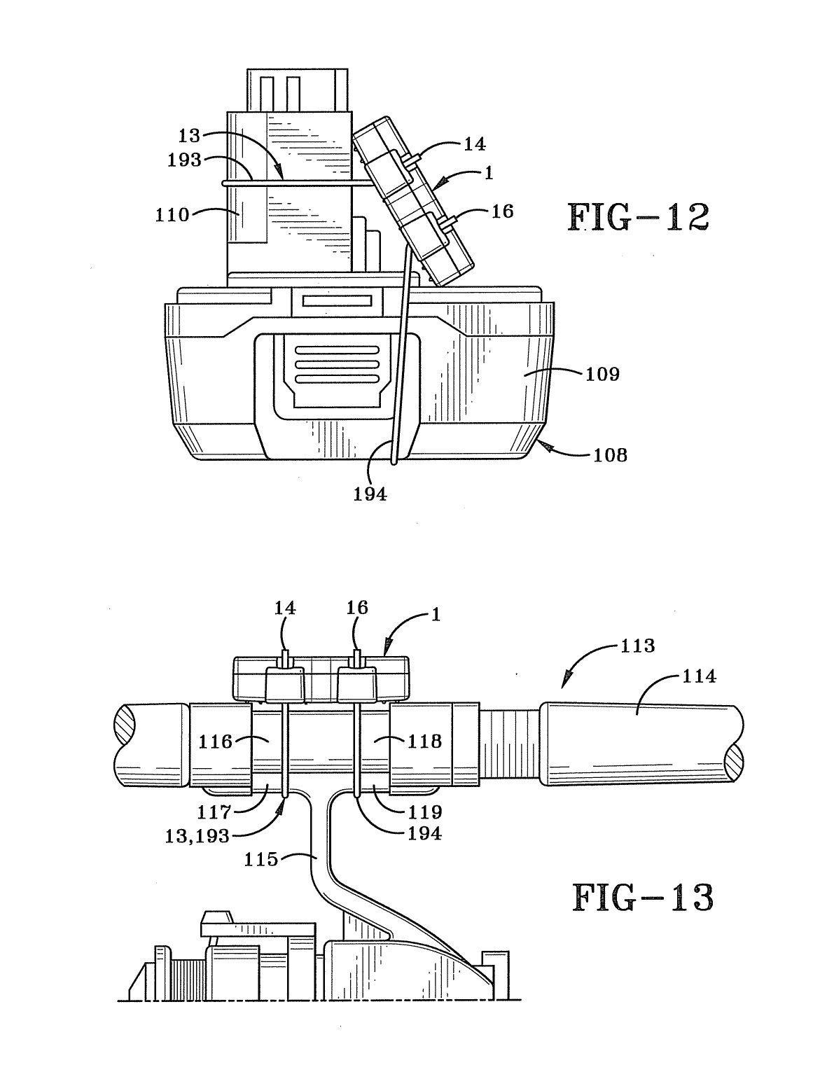

As shown in FIGS. 12 and 13, security device 1 may be secured to an article of goods in a variety of ways. As discussed previously, if article 2 includes a shaft-like portion, the arcuate cross-sectional shape of bottom portion 17 allows security device 1 to complementarily abut such a portion. If the article 2 also includes a threaded area on the shaft, fins 54 provide a method for securing security device 1 thereto, while allowing a user to unwind or unscrew security device 1 off article 2 when desired. However, if a particular article does not have an elongated shaft portion, first loop 193 can be extended around a portion, while second loop 194 can be extended around another portion to secure the particular article. As shown in FIG. 12, security device 1 may be secured to a removable cordless drill battery 108, which is free of a threaded shaft. First loop 193 is secured around a base 109 of battery 108, while second loop 194 is secured around an attachment shaft 110 of battery 108. Using this method for securing battery 108, bottom portion 17 generally abuts attachment shaft 110 of battery 108, however, a threaded abutment is not required for this method of using security device 1. While an outer surface 52 of device 1 includes the plurality of fins 54, security device 1 is not necessarily required to mate with a threaded shaft. A non-threaded shaft, or a shaft-like portion is sufficient for mating with security device 1 due to the highly configurable nature of cable 13, first loop 193, and second loop 194. Furthermore, as discussed previously, may be configured to have any desired cross-sectional shape for mating or abutting an article of goods.

An additional method of using device 1 is shown in FIG. 13, whereby security device 1 may be used to secure two portions of an article together to prevent both of the individual portions from being stolen. As shown in FIG. 13, security device 1 is secured to a fishing pole 115 comprised of two parts, a rod 114 and a reel 115. First loop 193 is extended around a portion 116 of rod 114 and a portion 117 of reel 115, while second loop 194 is extended around another portion 118 of rod 114 and another portion 119 of reel 115. Thus, security device 1 cannot slide off fishing pole 115, and rod 114 is secured to reel 115 by way of security device 1. Therefore, fishing pole 115 can be sold or displayed as a unit, without two separate anti-theft devices or mechanisms to protect rod 114 and reel 115 individually. Thus, security device 1 represents an enormous savings in costs and time for a retail establishment, in that articles that are comprised of two or more main portions may be protected by a single security device 1.

Inasmuch as security device 1 may be secured to non-threaded articles such as battery 108 and fishing pole 113, the method for removing device 1 by way of unscrewing or rotatably removing device 1 is generally not available. Thus, device 1 is removed by store personnel or the legal purchaser by cutting cable 13 with the appropriate cutting device (not shown). As such, the retail seller may leave device 1 on the particular article of goods until the legal purchaser wishes to remove device 1 at a secondary location (e.g. the job site, the purchaser's home), or the retail seller may supply a cutting device at the register to the checkout clerk for removal of device 1 at checkout.

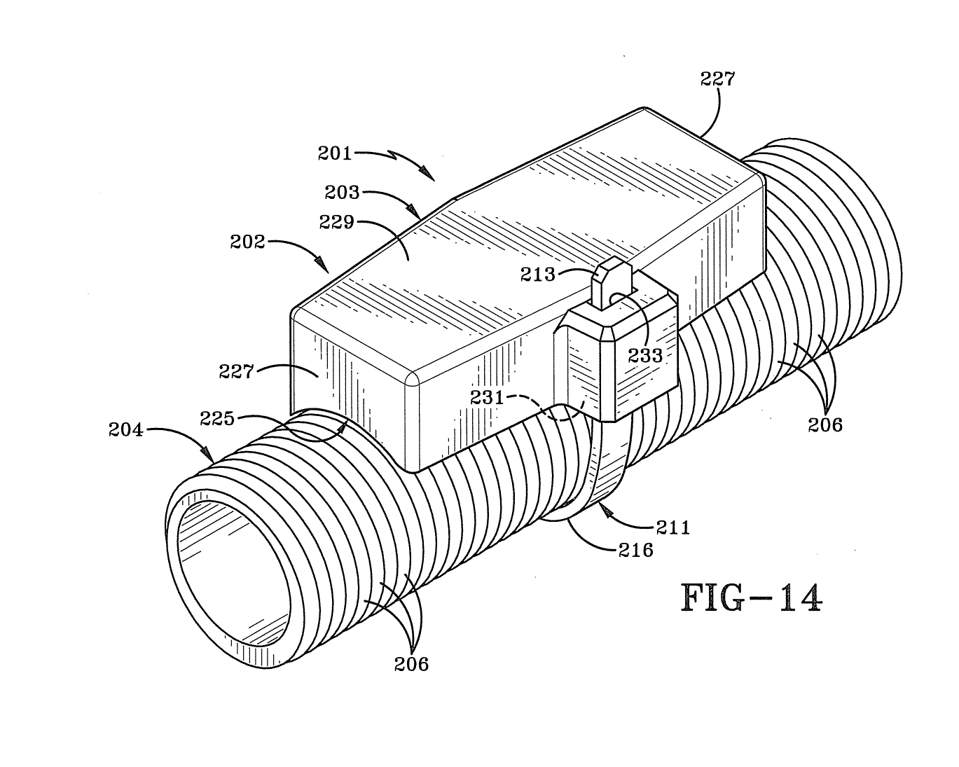

Another embodiment of a security device of the present invention featuring a cable tie or a cable tie fastener device is shown in FIGS. 14-19 and is indicated generally at 201. Cable tie device 201 is particularly well suited to secure an article 204 of goods which includes a plurality of threads 206 disposed thereupon. As shown in FIGS. 14-17, cable tie device 201 includes a housing 202, a security tag 205, and a cable tie 211. Housing 202 is comprised of a top portion 203 and a bottom portion 207 complementarily fitted together.

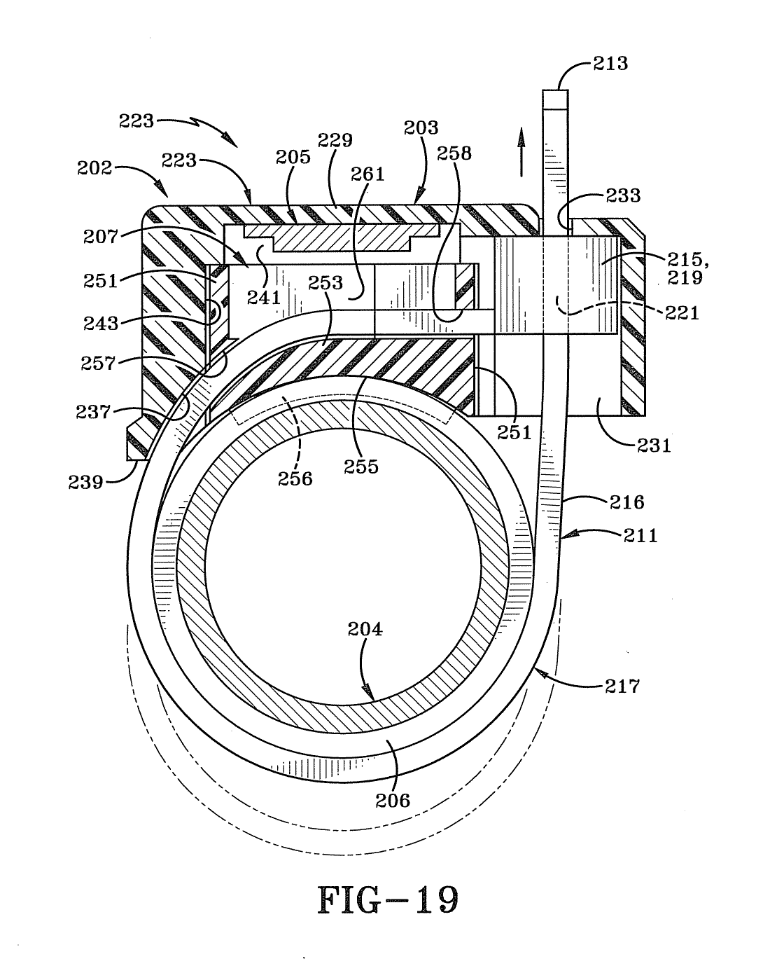

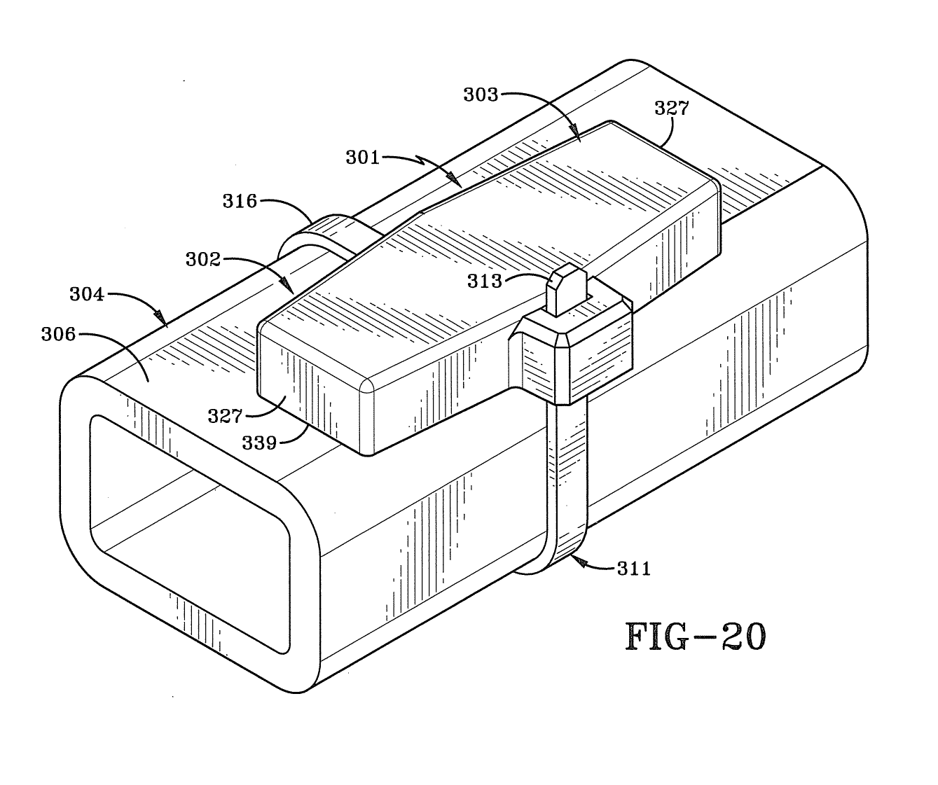

Referring particularly to FIG. 19, cable tie 201 may be specifically manufactured for use in cable tie device 201, or cable tie 201 may be a common off-the-shelf component. Cable tie 201 includes a first end 213 and a second end 215 with an elongated strap 216 extending therebetween. Second end 215 includes an enlarged lock 219 defining an aperture or channel 221 for extending first end 213 therethrough when cable tie 201 is locked. Cable tie 201 is lockably engageable with itself to non-releasably secure first end 213 to second end 215 by way of lock 219, thereby forming a loop 217. It is commonly known in the art that cable tie 201 and fasteners of this style typically include a gear rack (not shown) disposed on strap 216, and a ratchet (not shown) inside enlarged lock 219 proximate aperture 221 for abutting the gear rack to permanently lock strap 216 therein.

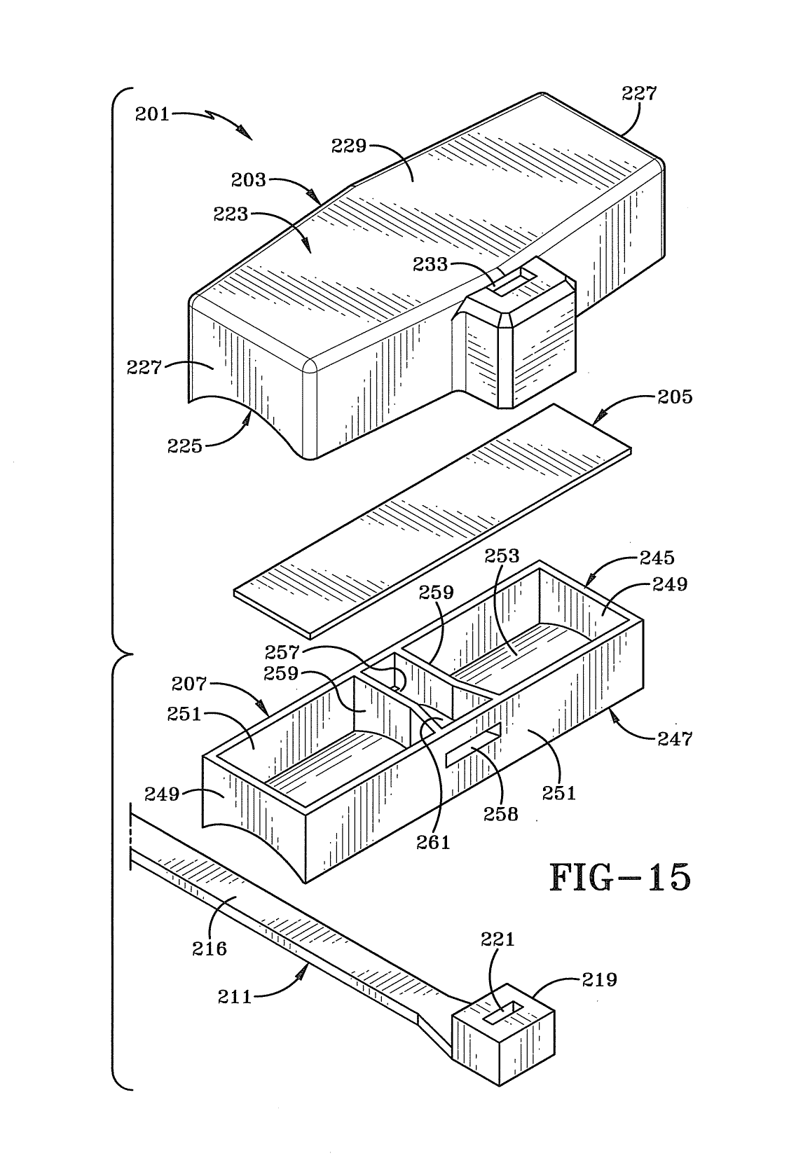

As shown in FIGS. 15, 17, and 19, top portion 203 is a box-like structure which includes an upper end 223, a lower end 225, a pair of sidewalls 227, a top wall 229 proximate upper end 223, a lock recess 231 (FIG. 17) defining an aperture 233, a strap brace 235 defining an aperture 237 (FIG. 19), and a bottom surface 239 (FIG. 19) extending about the periphery of housing 203 proximate lower end 225. Top portion 203 also includes an elongated security tag recess 241 defined by sidewalls 227 and top wall 229 and sized to receive security tag 205 therein. Top portion 203 further includes an elongated inner recess 243 (FIG. 19) sized to receive bottom portion 207 therein. As shown in FIG. 17, bottom surface 239 is arcuate in nature, generally bowed inward towards upper end 223.

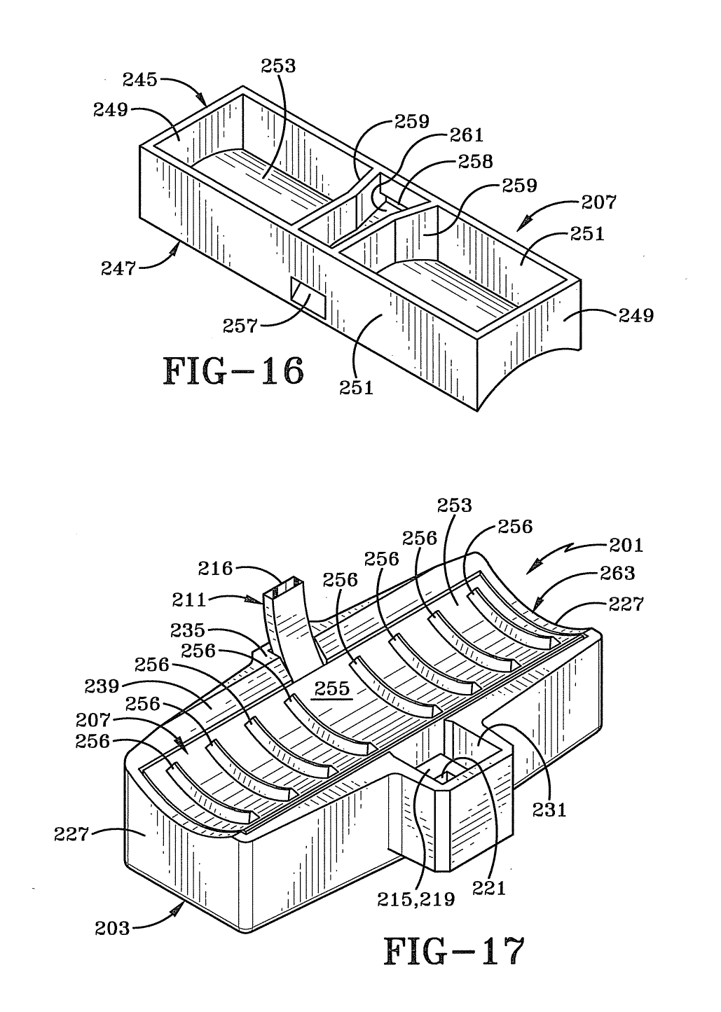

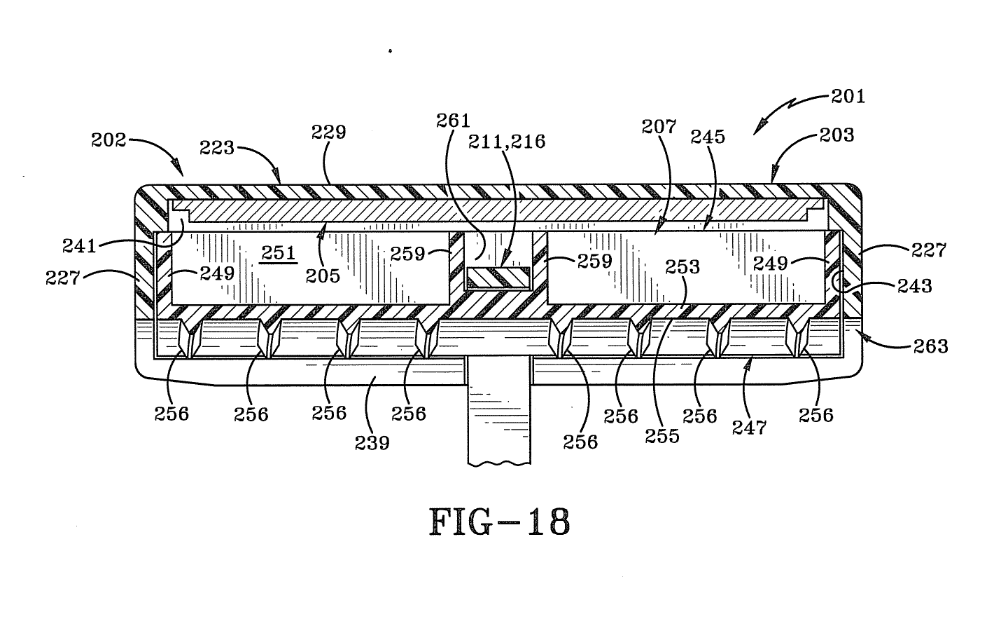

As shown particularly in FIGS. 15 and 16, bottom portion 207 is a box-like structure which includes an upper end 245, a lower end 247, a pair of sidewalls 249, a pair of sidewalls 251, and a bottom wall 253 having a bottom surface 255 (FIG. 17). A plurality of fins 256 are disposed on bottom surface 255 extending outwardly away therefrom. One of the sidewalls 251 and bottom wall 253 define a smaller aperture 257, whereby the other one of sidewalls 251 and bottom wall 253 define a larger aperture 258. As shown in FIG. 6, bottom portion 207 further includes a pair of channel walls 259 defining a channel 261 extending between aperture 257 and aperture 258. As shown in FIGS. 16 and 17, bottom surface 255 is arcuate in nature, generally bowed inward towards upper end 245.

Bottom portion 207 is sized to be received and secured within inner recess 243 of top portion 203. As shown in FIG. 19, when bottom portion 207 is disposed in inner recess 243, aperture 258 generally aligns with lock recess 231 in top portion 203, and aperture 257 generally aligns with aperture 237 of strap brace 235. As shown in FIGS. 17 and 19, bottom surface 239 of top portion 203 generally aligns with bottom surface 255 of bottom portion 207, such that surface 239 and surface 255 are generally complementary arced to form an overall arcuate cross-sectional shape. This provides a continuous outer arcuate surface 263 on housing 202. Surface 263 is formed to be particularly well suited for complementarily abutting an arcuate portion of article 204.

As shown in FIGS. 17-19, cable tie 201 is threaded through the various apertures in top portion 203 and bottom portion 207 to form cable tie device 201. As shown in FIG. 19, when second end 215 of cable tie 201 is disposed in lock recess 231, first end 213 is aligned to extend through aperture 258 and into channel 261. First end 213 is then aligned to extend through channel 261 and out aperture 257, which aligns first end 213 to enter strap brace 235 proximate bottom surface 239 of top portion 203. As such, first end 213 is thereby aligned to extend through aperture 237 in strap brace 235 and outwardly away from strap brace 235 and top portion 203. Thus, first end 203 and strap 216 are free to wrap around articles to form loop 217 and secure cable tie device 201 thereto.

Cable tie device 201 may be easily and intuitively assembled without tools or instructions by simply inter-connecting the four main component parts: top portion 203, bottom portion 207, cable tie 211, and security tag 205. Initially, the user extends first end 213 of cable tie 201 through aperture 258 in bottom portion 207. First end 213 is then passed through channel 261 and out aperture 257. First end 213 is thereafter passed through aperture 237 in strap brace 235, which connects bottom portion 207 to top portion 203 through cable tie 201. Lock 219 on second end 215 of cable tie 201 is then placed in lock recess 231, which is sized and configured to snuggly receive lock 219. Security tag 205 is then placed in security tag recess 241, and bottom portion 207 is placed in inner recess 243, thus pinning security tag 205 in top portion 203. First end 213 of cable tie 201 is unsecured and freely movable to form loop 217 around an article as desired by the user. Thus, cable tie device 201 is assembled yet unlocked position.

When cable tie device 201 is in the assembled state, bottom portion 207 is unsecured to top portion 203. However, top portion 203 is generally held in position by cable tie 211 threaded through the various apertures. Furthermore, the snug fit and tight tolerance between inner recess 243 and bottom portion 207 generally facilitates bottom portion 207 remaining in recess 243 of top portion 203. By foregoing a mechanical lock or direct one-way connection between top portion 203 and bottom portion 207, the overall cable tie device 201 is simplified, both from a manufacturing and assembly standpoint. Furthermore, bottom portion 207 may be removed from top portion 203 if desired by the user. For example, if top portion 203 is damaged or cable tie 211 is worn or needs replacing, top portion 203 and bottom portion 207 may be separated and the damaged component can be replaced.

In operation, a user assembles cable tie device 201 and secures it to article 204 for anti-theft purposes. When article 204 passes a security gate configured to interact with security tag 205, an alarm is sounded if security tag 205 has not been deactivated by store personnel. Cable tie 201 is secured to article 204 in generally the same method as one would secure a naked cable tie to article 204, by looping the cable tie back upon itself and locking the first end through the second end. As such, cable tie device 201 provides an easy method for the user to securely attach security tag 205 to article 204 using cable tie 201, and prevents tampering and removal of security tag 205 by way of the durable nature of housing 202.

It will be readily understood that loop 217 should be formed around a particular area of the article which will facilitate the non-removal of cable tie device 201. When the user selects a particular area on an article for placement of cable tie device 201, first end 213 of cable tie 201 is fed through the corresponding area or opening, and strap 216 is wrapped around the area to form loop 217. First end 213 is threaded through aperture 221 in lock 219 of second end 215 of cable tie 201 to thereby lock first end 213 to second end 215. As shown in FIGS. 6 and 7, aperture 233 of lock recess 231 is aligned with aperture 221 in second end 215 where first end 213 exists lock 219. As such, first end 213 exits aperture 221 of lock 219 and enters aperture 233, allowing first end 213 to extend outwardly from top portion 203. The user pulls first end 213 to tighten loop 217 around the article, thereby securing cable tie device 201 thereon.

Inasmuch as top portion 203 includes curved bottom surface 239, and bottom portion 307 includes curved bottom surface 255, cable tie device 201 is particularly well suited to engage a rounded surface of a tubular or curved article 204, and particularly if this article has a threaded nature and corresponding threads 206. When cable tie security device 201 is assembled, and curved outer surface 263 is formed on housing 202, fins 256 extend outwardly from curved outer surface 263 and are intended to be received into annular threads 206 of article 204 to provide an abutment between fins 256 and threads 206. This abutment prevents cable tie device 201 from sliding longitudinally off threaded article 204. Thus, cable tie device 201 is firmly secured to threaded article 204 by way of cable tie 211 and fins 256.

Inasmuch as lock 219 is a one-way lock, cable tie device 201 cannot be removed by retracting first end 213 back through lock 219. One method of removing cable tie device 201 is by unscrewing or rotating cable tie device 201 off threaded article 204, if possible. When unscrewing, fins 256 threadably unwind housing 202 when rotated against annular threads 206 and follow the groove-like threads 206 annularly towards the end of threaded article 204. Inasmuch as top portion 203 and cable tie 211 are connected to bottom portion 207, the entire cable tie device 201 is rotated off threaded article 204 when fins 256 are rotated against annular threads 206. If the unscrewing method of removal is unavailable, the user may also cut cable tie 211 to allow cable tie device 201 to be removed from article 204. This simply releases housing 202 from article 204, thus allowing the use of the underlying article 204.

It is envisioned that cable tie device 201 may be applied by store personnel, or alternatively the manufacturer of the goods may apply cable tie device 201 before final packaging of the product. Thus, it will be readily understood that an individual attempting to unscrew or cut cable tie 201 in a store would necessarily draw the attention of store personal, particularly if cable tie device 201 is disposed on article 204 within the shipping container or box that article 204 is sold in. As such, in addition to providing a secure connection between security tag 205 and an article, cable device 201 provides a strong deterrent to tampering as well. Furthermore, inasmuch as a would-be thief couldn't know which articles are secured by cable tie device 201 within a shipping container or box, other articles may be secured by proxy. It follows that a thief may be deterred from stealing even unsecured articles for fear they are secured by cable tie device 201.

Cable tie device 201 is particularly well suited for protecting high value, yet smaller sized articles such as high-end faucets, which often include a threaded faucet stud extending outwardly away therefrom. As discussed above, curved bottom surface 263 of housing 202 complementarily abut the curved outer surface of articles 204 such as a faucet stud, allowing a tight fit between cable tie device 201 and article 204. Thus, the unauthorized removal of cable tie device 201 from the faucet stud would require an individual to remove the faucet box from a shelf, open the box, remove the faucet, and thereafter attempt to cut cable tie 211, unwind cable tie device 201 off the faucet stud, or attempt to open top portion 203 to remove security tag 205. The aforementioned steps would necessarily require a significant amount of time, likely drawing the attention of store personnel, thereby preventing theft of the article. While unscrewing cable tie device 201 off of threaded article 204 is the intended method of removal, a significant amount of time and manual manipulation is required to do so, which would also draw the attention of store personnel if conducted by an unauthorized individual.

Cable tie device 201 may be removed either by store personnel at the retail store, or by the end user at a remote location. In the event that store personnel remove cable tie device 201, cable tie device 201 represents an advantage over other security devices in that cable tie device 201 does not require store personnel to use a key or enter a code or any other method of removing cable tie device 201 from the article. This allows the checkout person to remove cable tie 201 at the checkout counter quickly, which increases efficiency and the speed with which secured products can be processed and sold. Cable tie 201 is simply unscrewed or severed to remove cable tie device 201 from article 204 by the store personnel at the checkout counter.

In the event that the end user removes cable tie security device 201, security tag 205 would be deactivated by store personnel at the point of purchase and the buyer would remove cable tie device 201 when the purchased product is unwrapped at a remote location. In this scenario, the manufacturer and retail store may consider cable tie device 201 a “throw away” device, as it would leave the store with the purchaser. The manufacturer or retail store may also provide a rebate or another type of incentive for the purchaser bring cable tie device 201 back to the retail store. This may facilitate return visits to the retail store by the purchaser, which will be readily understood to be desirable to the retail store. The purchaser may also be incentivized in some way to mail cable tie device 201 back to the manufacturer. In this way, cable tie security device 201 may act as a marketing tool for the retailer to drive return business and repeat customers.

Inasmuch as cable tie device 201 may be removed by unscrewing cable tie 201 or cutting cable tie 211, cable tie device 201 provides an efficient means for reusing top portion 203, security tag 205, and bottom portion 207 to re-form the cable tie device 201 by adding another cable tie 201. First end 213 remains locked with second end 215 in lock 219, however, first end 213 may be retracted out of aperture 233, thereby allowing removal of lock 219 from lock recess 231. Lock 219 is then pulled by the user out of lock recess 231 which retracts strap 216 through aperture 237, thus allowing the user to pull the remaining strap 216 out of bottom portion 207. Top portion 203 and bottom portion 207 are then free to receive another uncut cable tie 201 to reform cable tie device 201. It will be readily recognized that common cable ties 211 are very low cost items which are easily replaced and therefore allow for reuse of the more expensive components of cable tie device 201. Thus, while removal of cable tie device 201 requires damaging one of the components (cable tie 201), this component is very inexpensive and readily available. Therefore, an extremely efficient method is provided for reusing cable tie device 201.

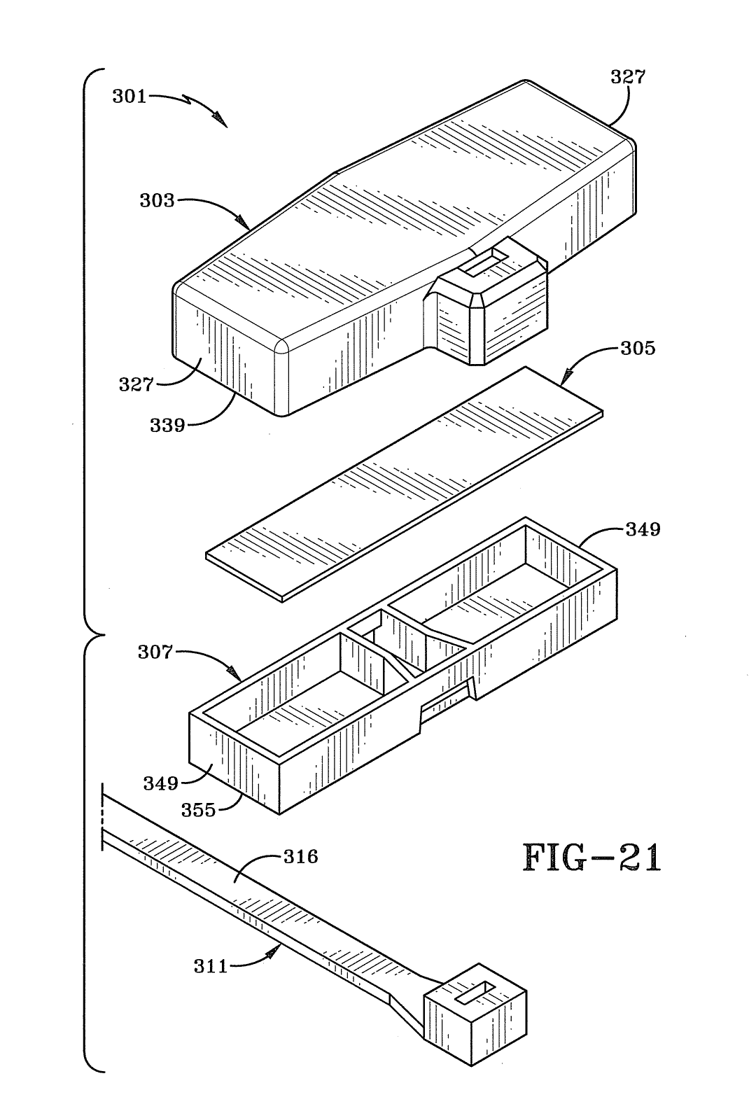

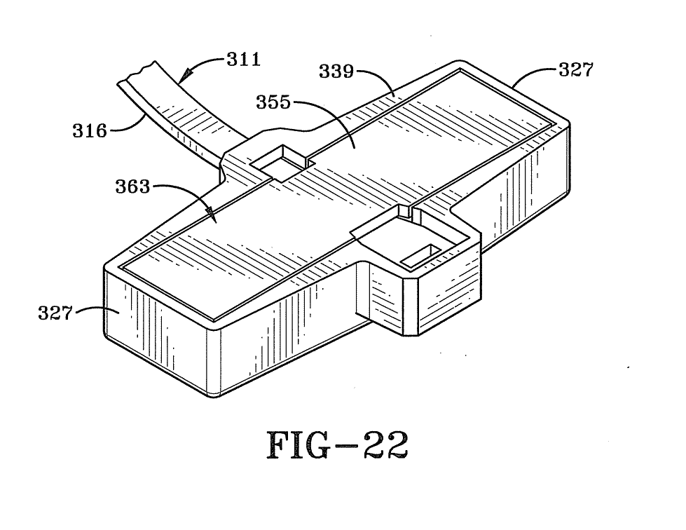

Another embodiment of a cable tie style security device of the present invention is shown in FIGS. 20-23 and is indicated generally at 301. As shown in FIGS. 2, cable tie device 301 is similar in most respects to cable tie device 201. However, cable tie device includes a housing 302 comprised of a top portion 303 and a bottom portion 307 complementarily fitted together. Top portion 303 includes a pair of sidewalls 327 terminating in a bottom surface 339 which does not curve in an arcuate shape. Rather, bottom surface 339 is flat and planer when compared to bottom surface 239. Similarly, bottom portion 307 includes a pair of sidewalls 349 terminating in a bottom surface 355 which does not curve in an arcuate shape. Rather, bottom surface 355 is flat and planer when compared to bottom surface 255. Bottom surface 339 and bottom surface 355 form a flat bottom surface 363 when top portion 303 is fitted together with bottom portion 307. Thus, the primary difference between cable tie device 201 and cable tie device 301 is the overall cross-sectional shape has been altered from the arcuate outer surface 263 to the flat outer surface 363. All other elements are generally identical between cable tie device 301 and cable tie device 201.

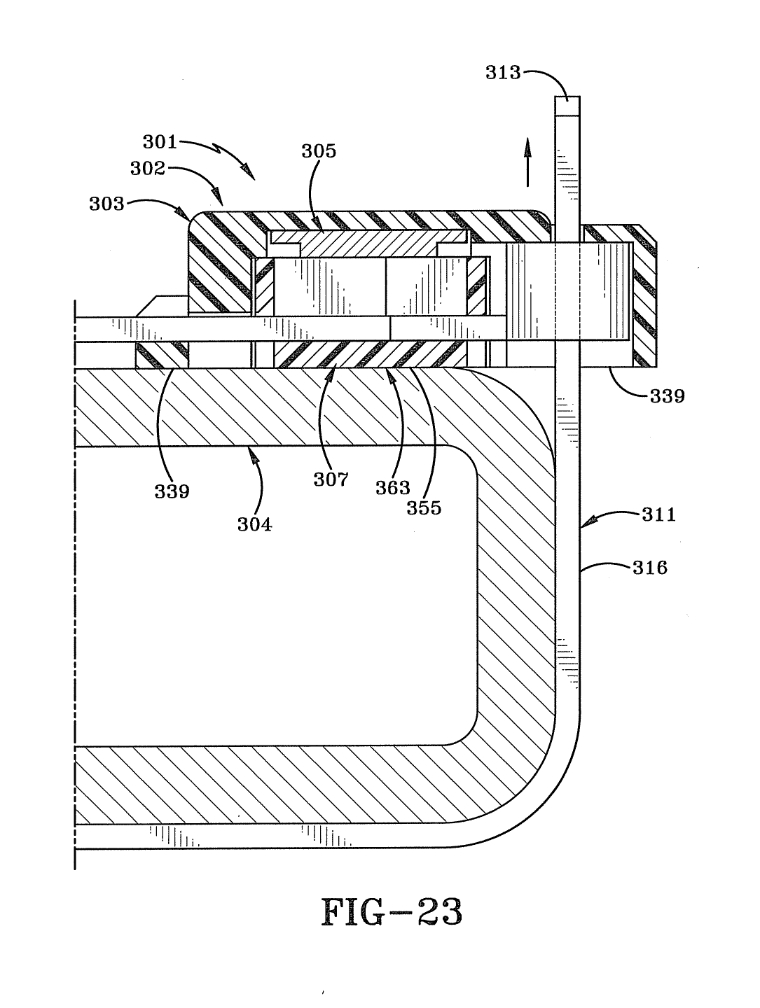

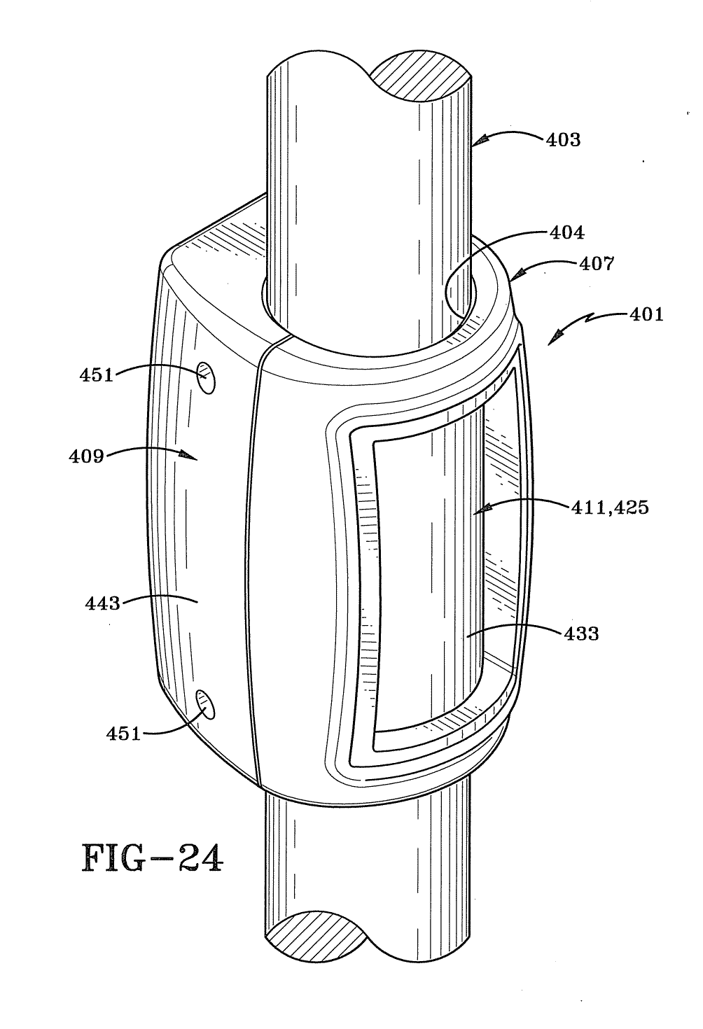

Given the flat planer nature of bottom surface 363, cable tie device 301 is particularly well suited to secure articles 304 of goods which include a flat area 306, as shown in FIG. 20. As shown in FIG. 23, when cable tie device 301 is secured to article 304, outer surface 363 formed by bottom surface 339 and bottom surface 355 firmly abuts flat area 306 of article 304. One will readily understand that the unscrewing or unwinding technique available with cable tie device 201 is not available for cable tie device 301. Given the flat nature of outer surface 363 and the underlying cross-sectional shape of article 304 is rectangular, twisting or axially rotating cable tie device 301 is not possible. As such, cable tie device 301 must be cut off article 304 to remove cable tie device 301 therefrom. This may be accomplished as described above for cable tie device 201, namely by the retail store employee at checkout or by the end purchaser before use.

It will be readily understood that cable tie security devices 201 or 301 may be modified to more closely resemble security device 101, particularly regarding incorporating two cable ties 211/311 into the security device. All of the advantages discussed with respect to security device 101 also apply to cable tie security devices 201 and 301. Furthermore, cable ties 211/311 may be more cost effective for incorporating into security device 101, rather than cable 13. As such, cable tie security devices 201 and 301 adhere to the spirit of the invention in that they provide for an easy to assemble yet disposable security device which may be applied at the point of manufacture and removed by the end purchaser.

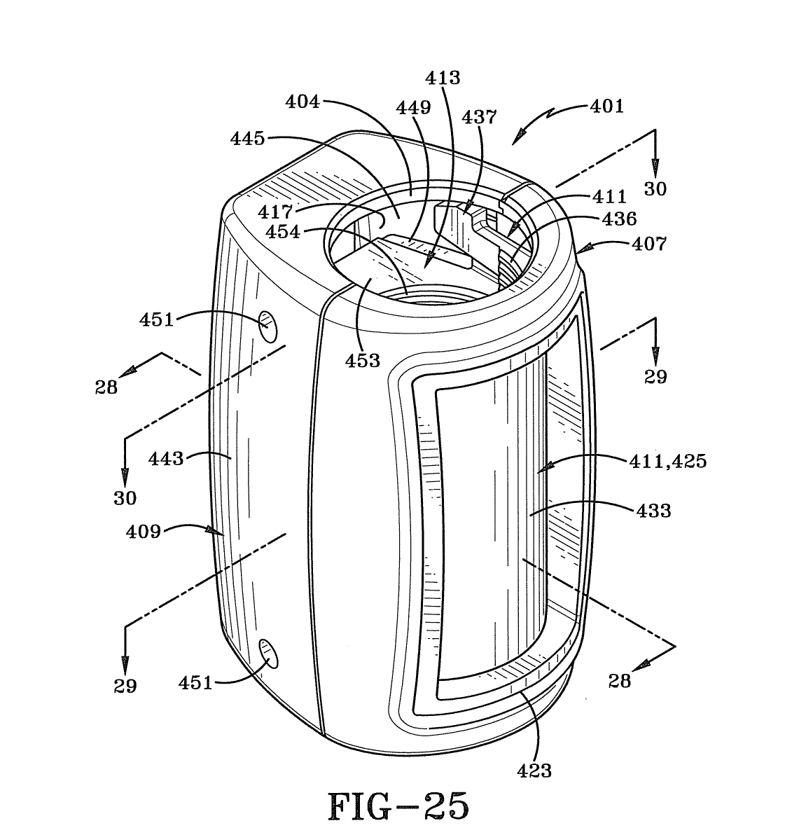

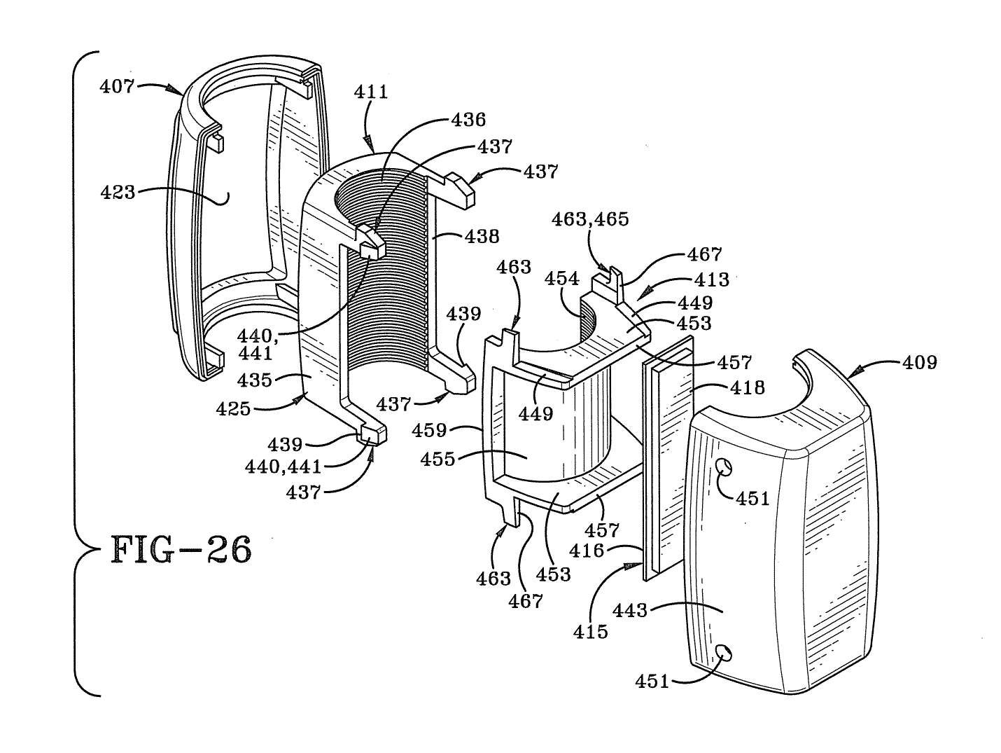

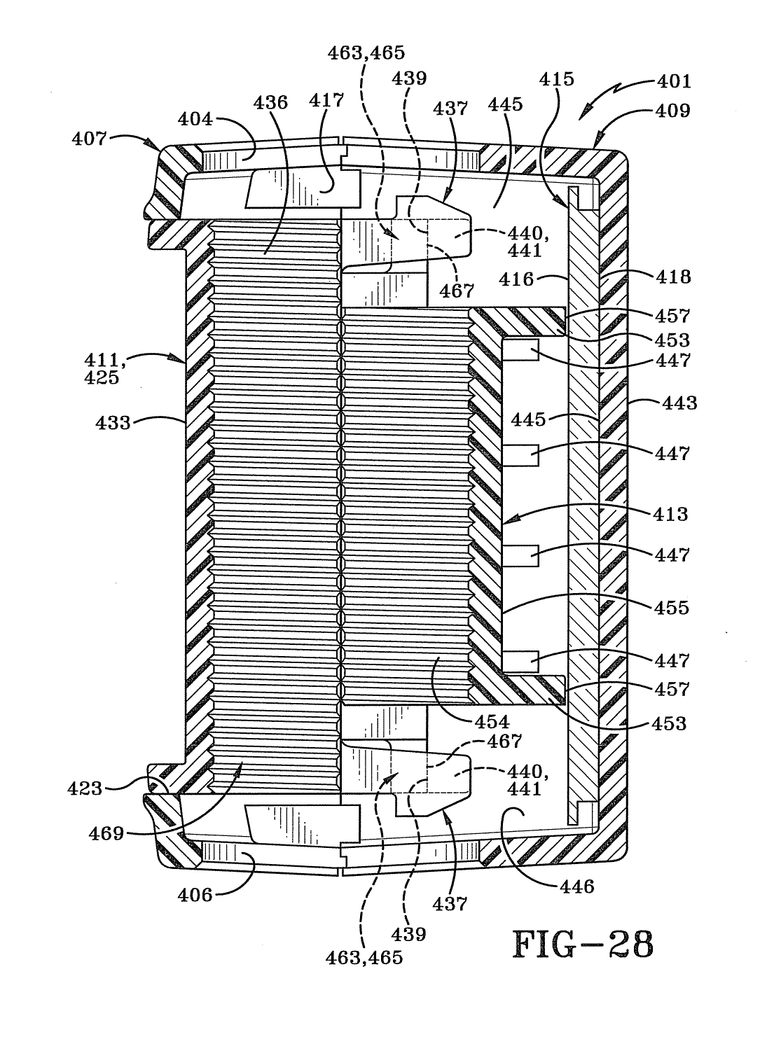

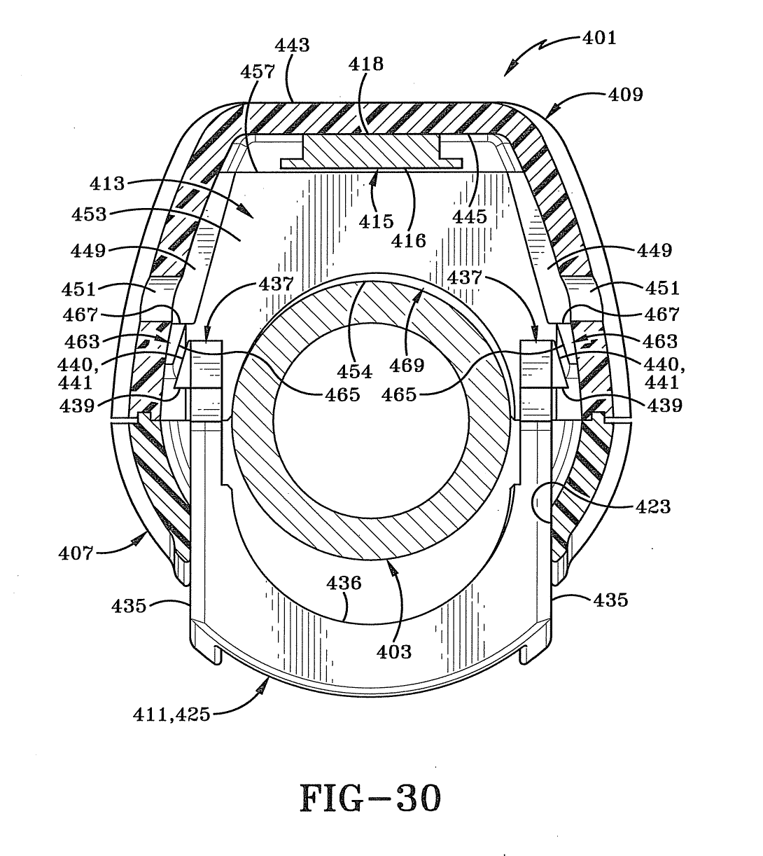

Another embodiment of a security device of the present invention is shown in FIGS. 24-36 and is indicated generally at 401. As shown in FIG. 24, device 401 is intended to be secured to a threaded article 403, which may be a pipe, a faucet stud, or any other article having an elongated length with threading thereon. As shown in FIGS. 25-28, device 401 includes a housing 405 defining a top aperture 404, a bottom aperture 406, and formed from a first housing member 407 and a second housing member 409. Device 401 further includes a slidable first lock member 411, a second lock member 413, and a security tag 415 having a front surface 416 and an opposed back surface 418. First housing member 407 and second housing member 409 are secured together by a peripheral projection 408 disposed on first housing member 407 which is received by a complementarily shaped peripheral recess disposed on second housing member 409 (FIG. 29). First housing member 407 and second housing member 409 are secured together by sonic welding or adhesive to form an inner chamber 417 (FIG. 25), wherein second lock member 413 and security tag 415 are disposed in inner chamber 417. Housing 405 defines a first aperture 419 and a second aperture 421 through which threaded article 403 extends to pass through device 401.

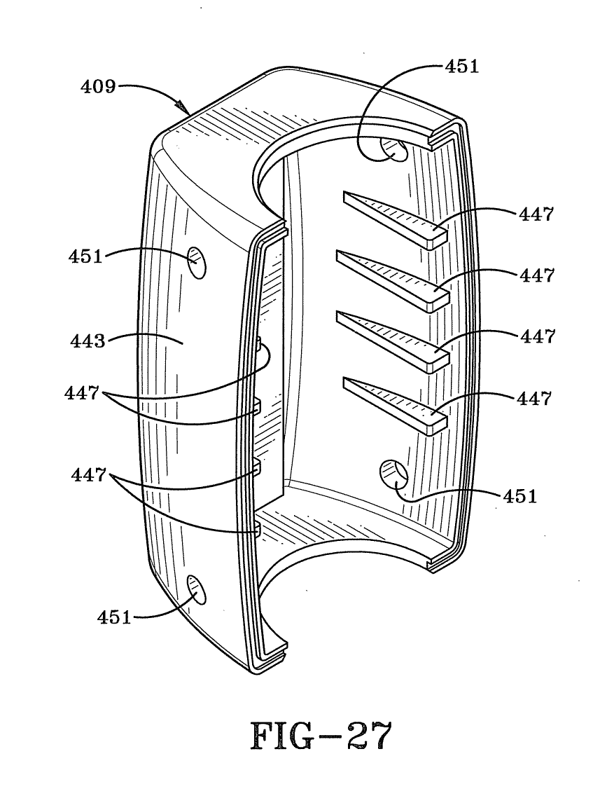

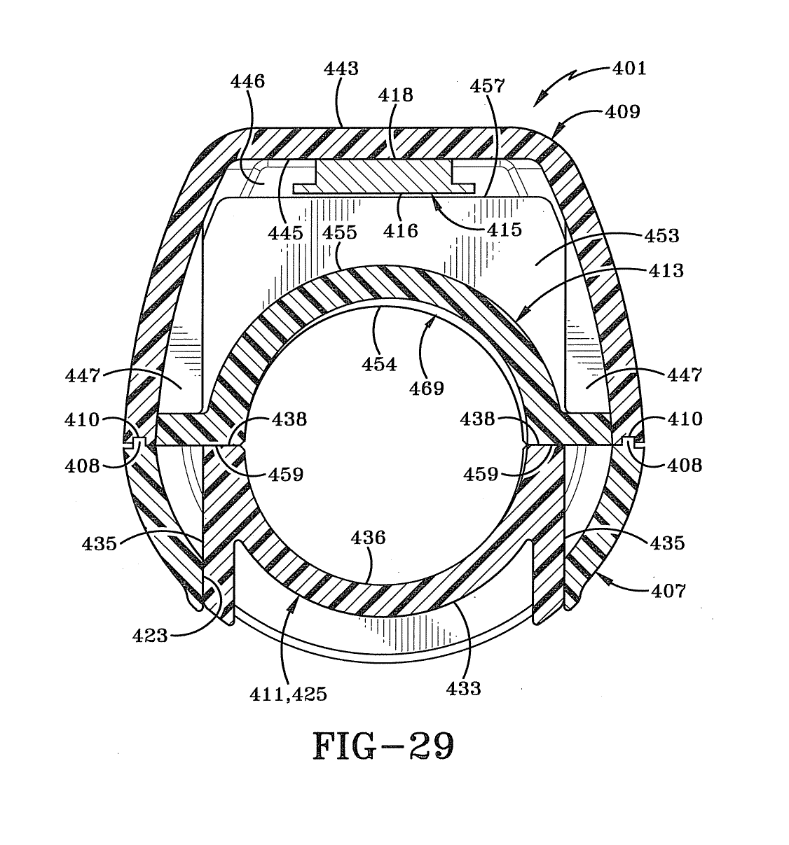

Referring to FIGS. 26 and 28, first housing member 407 includes a button aperture 423 sized to pass a button 425 formed on first lock member 411 therethrough. Button 425 is the portion of first lock member 411 which passes through button aperture 423 and extends outwardly from housing 405. First housing member 407 further includes a generally smooth outer surface 427 and an inner surface 429. Extending between outer surface 427 and inner surface 429 is a smooth generally rectangular slider surface 431 which defines button aperture 423.

First lock member 411 includes a button surface 433, a side surface 435 extending therefrom and a threaded inner arcuate surface 436. Integrally formed on first lock member 411 are a plurality of lock arms 437, shown in the preferred embodiment as four lock arms 437. Each lock arm 437 include a beveled surface 440 and a lock surface 439 formed on a lock shoulder 441 disposed on the outermost portion of each lock arm 437. Extending between each pair of lock arms 437 is a flat longitudinal surface 438.

As shown in FIGS. 26-28, second housing member 409 includes a smooth outer surface 443 and an inner surface 445 which form an inner cavity 446. A plurality of brace ribs 447 extend from inner surface 445 and are sized to fittingly abut spaced rib recesses 449 disposed on second lock member 413 thereby bracing and aligning second lock member 413 in inner cavity 446. Second housing member 409 further optionally includes a plurality of apertures 451 extending from outer surface 443 to inner surface 445 and communicate with inner cavity 446.

Second lock member 413 includes a pair of ledges 453 with an outer annular surface 455 extending therebetween and an inner annular threaded surface 454. Rib recesses 449 are disposed in pairs on each ledge 453. Each ledge includes an edge surface 457 spaced apart and generally parallel with a longitudinal surface 459. A pair of side surfaces 461 extend therebetween. Proximate each rib recess 449 is a locking wedge 463 having a beveled surface 465 and a lock surface 467. Each locking wedge 463 is aligned and positioned to engage each a corresponding lock shoulder 441 on first lock member 411.

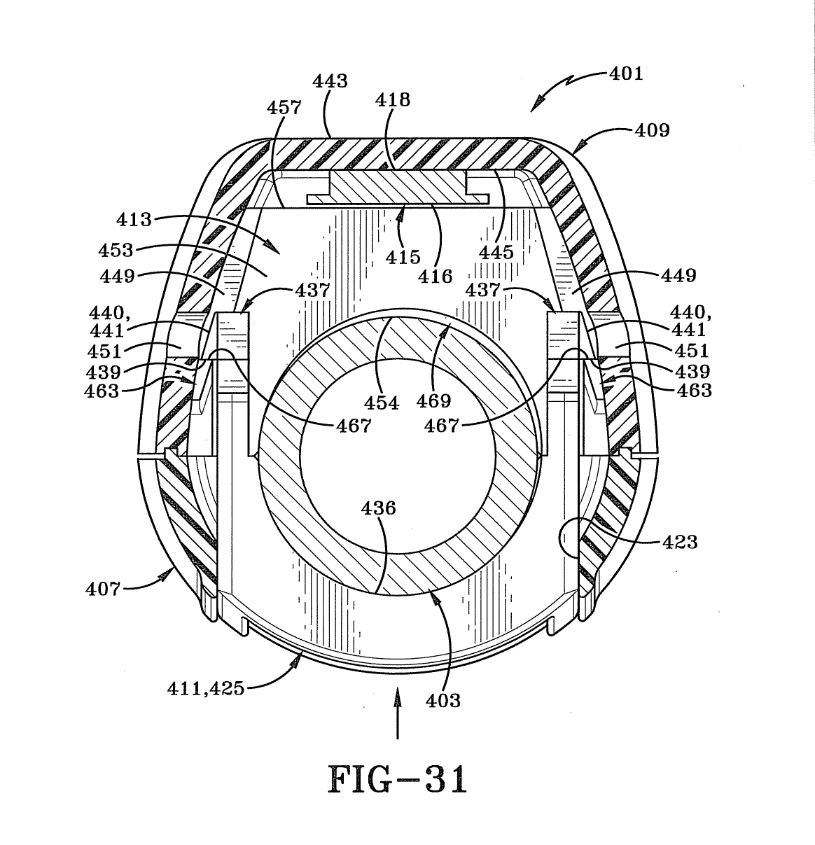

As shown in FIGS. 26, 28, and 30, when button 425 is in the first position (FIG. 30), first lock member 411 is aligned with button aperture 423 such that button 425 extends outwardly away from housing 405 through button aperture 423. Side surface 435 of first lock member 411 slidably abuts slide surface 431 of first housing member 407. This sliding abutment allows first lock member 411 to slide from the first position whereby button 425 is extended outwardly away from housing 405 (FIG. 30) to a second position whereby button surface 433 is generally aligned with outer surface 427 of first housing member 407 (FIG. 31). When button 425 is in the first position, device 401 is in an unlocked state. Likewise, when button 425 is in the second position, device 401 is in a locked state.

While first lock member 411 is slidable relative to housing 405, second lock member 413 is generally stationary with respect to housing 405. Second lock member 413 is disposed within inner cavity 446 and held therein by an abutment between brace ribs 447 and rib recesses 449. As shown in FIG. 29, rib recesses 449 are sized to complementarily receive ribs 447 in a firm abutting engagement such that second lock member 413 is generally stationary within housing 405. Security tag 415 is disposed between second lock member 413 and second housing member 409 within inner cavity 446. As shown in FIG. 29, front surface 416 of security tag 415 abuts surface 457 of second lock member 413 when second lock member 413 is disposed within inner cavity 446. Similarly, back surface 418 of security tag 415 abuts inner surface 445 of second housing member 407 when second lock member 413 is disposed within inner cavity 446. Security tag 415 is thereby pinned between second housing member and second lock member 413 and held securely therebetween.

Turning now to FIGS. 30 and 31, button 425 is shown moving from a first position (FIG. 30) to a second position (FIG. 31) which corresponds to device 401 moving between an unlocked state (FIG. 30) to a locked state (FIG. 31). This locking engagement is facilitated by the interaction between lock shoulders 441 on first lock member 411 and locking wedges 463 on second lock member 413. When button 425 is in the first position, device 401 is in the unlocked state. As shown in FIG. 30, when device 401 is in the unlocked state, beveled surface 440 of each lock shoulder 441 are positioned proximate beveled surface 465 of each locking wedge 463. Beveled surfaces 437 and 465 are configured to slidingly abut one another as button 425 moves from the first position to the second position. As button 425 is depressed to move first lock member 411, beveled surface 440 of each lock shoulder 441 slides along beveled surface 465 of each locking wedge, thereby flexing each lock arm 437 inwardly. This flexing generates an outward bias in each lock arm 437 as button 425 is depressed from the first position to the second position. When beveled surface 440 passes beveled surface 465, the outward bias on lock arm 437 is released such that each lock arm 437 snaps back into the unbiased position to lockingly abut lock surface 439 on each lock shoulder with lock surface 467 on each locking wedge 463.

As shown in FIG. 31, device 401 is in the locked state and lock surfaces 439 are in an abutting relationship with lock surfaces 467. Lock surfaces 439 and 467 are configured to prevent first lock member 411 from disengaging second lock member 413 once this abutment is realized. Thus, device 401 includes a one-way pressure lock such that when device 401 is moved from the unlocked state to the locked state, device 401 may only be removed from threaded article 403 by unscrewing device 401 off of threaded article 403.

In operation, threaded article 403 is inserted into device 401 such that the threads (not shown) on threaded article 403 are generally aligned with threaded surfaces 436 and 454. Device 401 is inserted onto threaded article 403 in the unlocked state (FIG. 30) whereby button surface 433 of button 425 is pressed by the user to move device 401 into the locked state (FIG. 31). In the locked state, device 401 may only be removed from threaded article 403 by unscrewing device 401 such that the threads of threaded article 403 direct device 401 off of threaded article 403.

As shown in FIG. 28, threaded surface 436 of first lock member 411 generally aligns with threaded surface 454 of second lock member 413 when device 401 is in the locked state such that one continuous annular thread 469 is formed. Annular thread 469 is complementary-shaped and sized to fit the threads of a particular threaded article 403. As such, device 401 may be unscrewed from the threads of threaded article 403 to facilitate removal of device 401. It is readily understood that unscrewing device 401 from threaded article 403 would typically require a thief or shoplifter to manipulate device 401 for an amount of time within the store to remove device 401 from threaded article 403. This manipulation of device 401 would naturally draw the attention of loss prevention personnel within the store, resulting in either apprehension of the individual, or preemptively discouraging the individual altogether from shoplifting threaded article 403. As device 401 is applied to threaded article 403 directly, and is not disposed on the packaging or box containing threaded article 403, tearing or ripping the packaging has no effect on the security of threaded article 403. It is also envisioned that device 401 may be applied by the manufacturer of threaded article 403 prior to shipping. Furthermore, security tag 415 may be an electronic article surveillance (EAS) tag or it may be a more advanced security tag without departing from the spirit of the invention. It will also be readily understood that threaded surfaces 436 and 454 may be formed having any other surface shape or texture which complements the outer surface of the intended product to be secured and to sufficiently hold device 401 thereon.

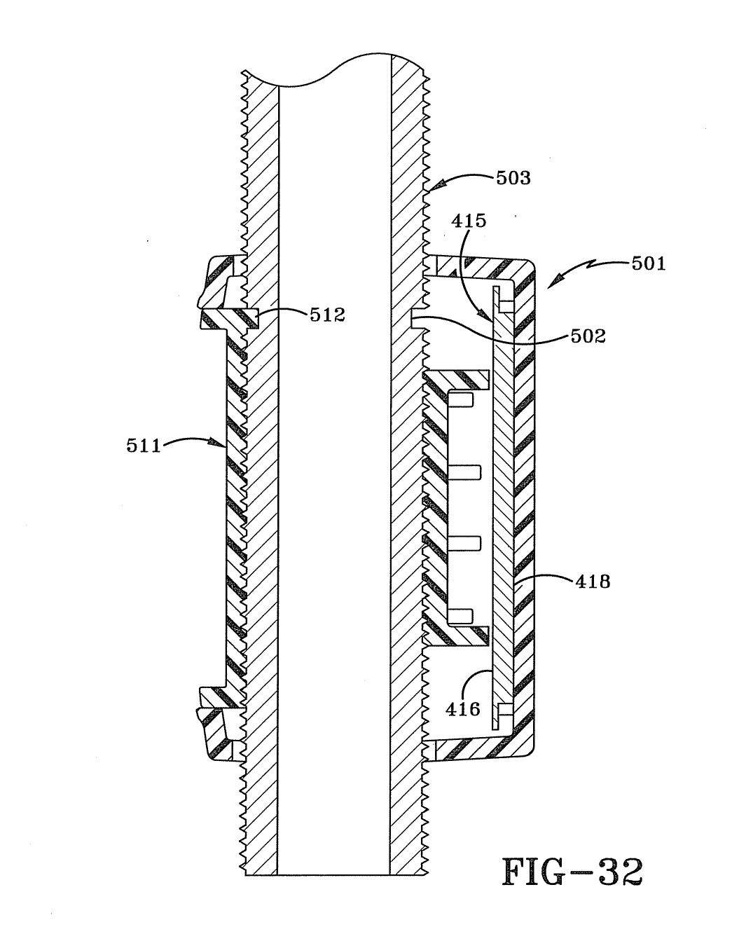

As shown in FIG. 32, in another embodiment of the anti-theft device, indicated generally at 501, an article 503 may include an annular recess 502. Device 501 includes a first locking member 511 which is similar to first locking member 411, however, first locking member 511 includes a projection 512 generally sized to fit into recess 502. As such, when device 501 is in the locked state, projection 512 fits within recess 502 to secure device 501 on article 503. It will be readily understood that as projection 512 is fittingly received in recess 502, device 501 may not be unscrewed from article 503. Therefore, device 501 is formed of a soft plastic material or rubber, namely ethylene propylene diene Monomer (EPDM) rubber, so that a user may cut or saw device 501 off of article 503 as desired to remove device 501 from article 503.

Article 503 may have an outer surface which does not include threads. For example, article 503 may have a ribbed or smooth outer surface, a bore hole extending through the outer surface, or the outer surface may include any other style of surface texturing common in the art. As such, first locking member 511 may be formed to have any particular longitudinal shape which complementarily conforms to the outer surface of the intended article.

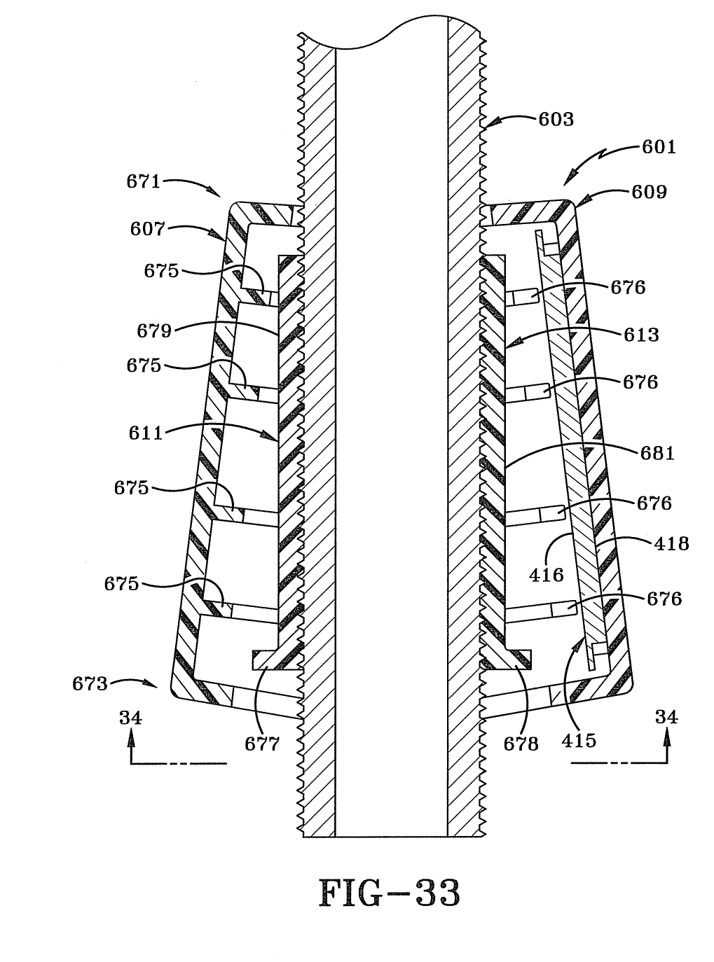

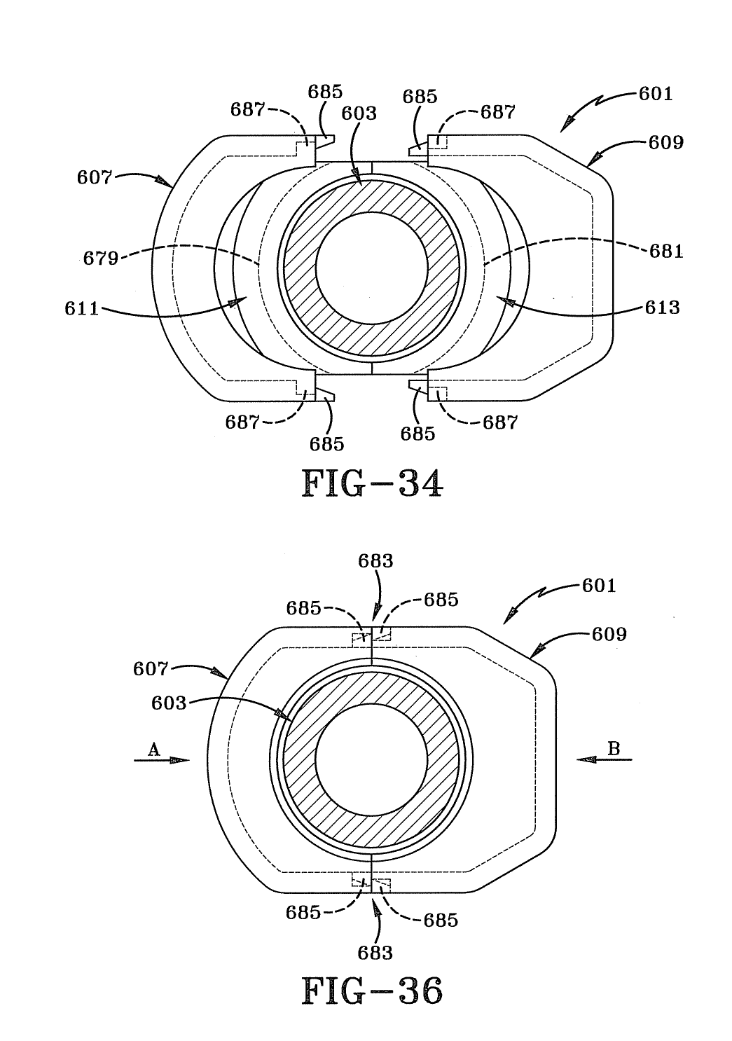

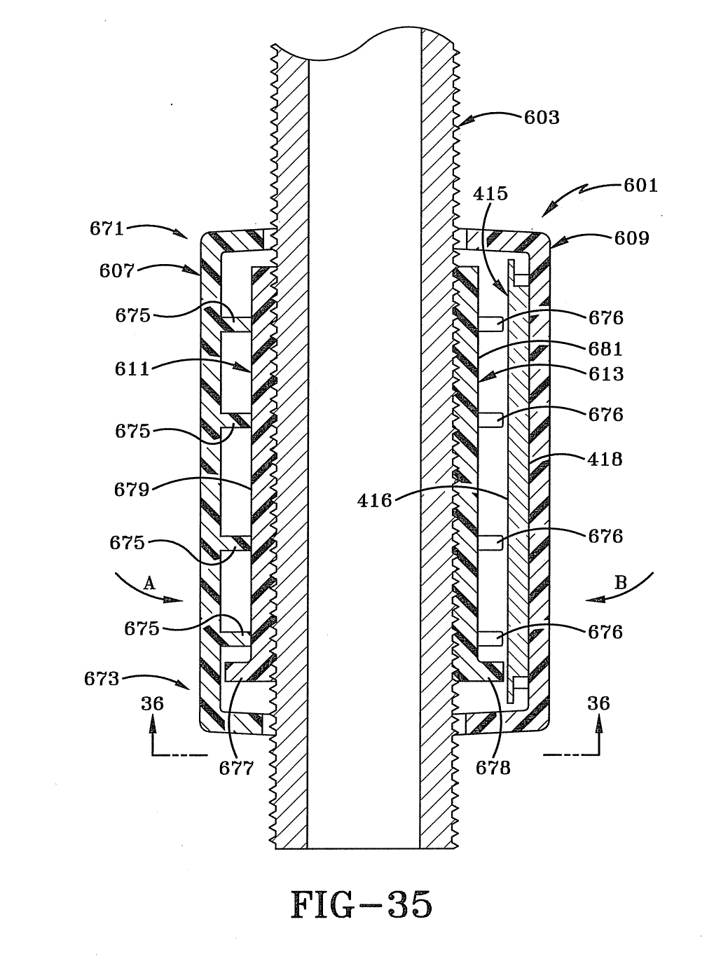

As shown in FIGS. 33-36, in another embodiment of the anti-theft device, indicated generally at 601, a first lock member 611 and a second lock member 613 are engaged with threaded article 603. Similarly to device 401, a housing 605 includes a first housing member 607 and a second housing member 609. Housing 605 includes an upper end 671 and a spaced apart lower end 673, whereby first housing member 607 and second housing member 609 are movably connected proximate top end 671 to move device 601 between an unlocked state (FIGS. 33 and 34) and a locked state (FIGS. 35 and 36). As shown in FIG. 35, first housing member 607 is moved in the direction of Arrow C and second housing member 609 is moved in the direction of Arrow D to move device 601 from the unlocked state to the locked state. First housing member 607 is locked with second housing member 609 proximate lower end 673 by way of a pair of snap fit connections 683. Each snap fit connection 683 includes a projection 685 and complementary recess 687 on both first housing member 607 and second housing member 609. As shown in FIG. 36, first housing member 607 is moved in the direction off Arrow A, and second housing member 609 is moved in the direction of Arrow B to engage projections 685 with recesses 687. While such a snap fit connection 683 is preferred, it will be readily understood that any means for sufficiently locking first housing member 607 to second housing member 609 is encompassed by the embodiment of device 601.

As shown in FIG. 33, an outer surface 679 and an inner brace rib 677 are located on first lock member 611, and an outer surface 681 and an inner brace rib 678 are located on second lock member 613. As device 601 is moved to the locked state, a plurality of outer brace ribs 675 located on first housing member 607 press against outer surface 679, and first housing member 607 presses against inner brace rib 677 such that first locking member 611 is firmly held against threaded article 603. Likewise, as device 601 is moved to the locked state, a plurality of outer brace ribs 676 located on second housing member 609 press against outer surface 681 and second housing member 609 presses against inner brace rib 678 such that second locking member 613 is firmly held against threaded article 603. Thus, when device 601 is in the locked state, housing 605, first lock member 611, and second lock member 613 are firmly secured to threaded article 603 such that the only reasonable method for removing device 601 from threaded article 603 is by unscrewing device 601 off of threaded article 603.

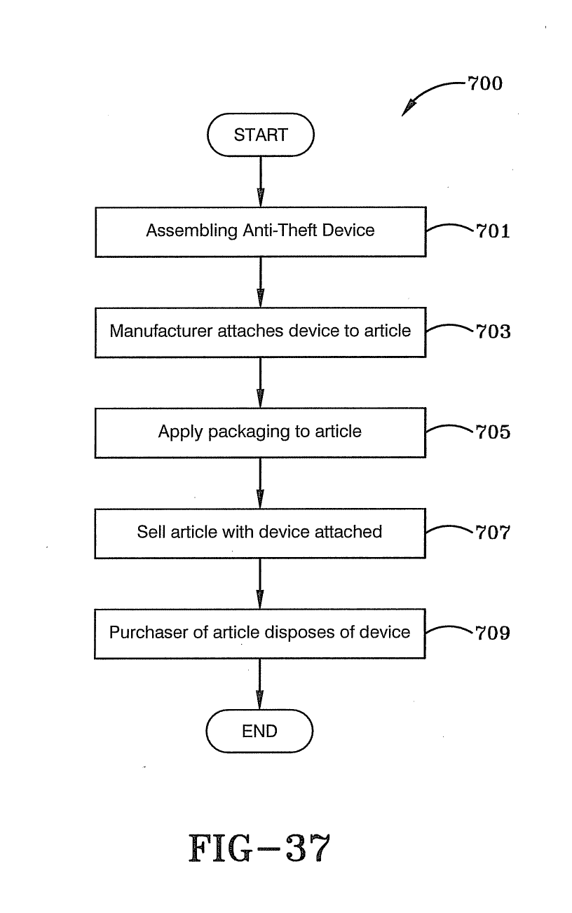

As shown in FIG. 37, a diagram for a method 700 of protecting article 2 (or any article) of goods using security devices 1, 201, 301, 401, 501, and 601 is provided. Security device 1 will be included in the description of the steps of method 700, however, it will readily be understood that any of security devices 1, 201, 301, 401, 501, and 601 may be used therewith and without departing from the spirit of the invention.

Method 700 begins with a step 701 of assembling the device 1. Step 701 may be performed by one of the device manufacturer, the article manufacturer, or the retail store. Next, the manufacturer attaches device 1 to article 2 in a step 703. Packaging is then applied to article 2 in an optional step 705. Packaging may be any type commonly used in any industry, including shrink-wrap, bubble-packaging, blister-pack, boxes, containers, or any packaging type of material or materials. Article 2 is then offered for sale with the device attached in a step 707. Finally, in a step 709, the purchaser of the device disposes of security device 1 after purchasing article 2. Thus, security device 1 may reside on article 2 during the sales process, yet a retail store employee is not required to remove or apply security device 1 to article 2 during the retail life of article 2.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A disposable anti-theft security device adapted to be secured to an article of goods, said security device comprising:
a housing defining an internal chamber;
a security tag disposed in the internal chamber;
a first flexible member extending from the housing and terminating in a first end, wherein the first flexible member is adapted to encircle a first portion of the article; and
a first one-way locking member disposed in the housing and configured to receive the first end of the first flexible member to permanently lock the first flexible member to the housing.

2. The anti-theft security device of claim 1, wherein the first flexible member is an elongated length of cable joined at a middle section with the second flexible member.

3. The anti-theft security device of claim 2, wherein the middle section is disposed in the internal chamber.

4. The anti-theft security device of claim 3, the first one-way locking member comprising:
a projection area;
a nut recess defined by the projection;
a locking nut disposed in the nut recess; and
wherein the locking nut permanently locks the first flexible member therein.

5. The anti-theft security device of claim 4, further comprising a top member and a bottom member joined together to form the housing, and wherein the top member and the bottom member form an offset seal therebetween.

6. The anti-theft security device of claim 5, wherein the housing includes a bottom surface, and wherein at least one fin extends outwardly away from the bottom surface.

7. The anti-theft security device of claim 6, wherein the bottom surface is arcuate.

8. The anti-theft security device of claim 6, further comprising:
a second flexible member extending from the housing and terminating in a second end, wherein the second flexible member is adapted to encircle a second portion of the article; and
a second one-way locking member disposed in the housing and configured to receive the second end of the second flexible member to permanently lock the second flexible member to the housing.

9. The anti-theft security device of claim 1, wherein the first flexible member is a cable tie fastener device having a second end spaced apart from the first end.

10. The anti-theft security device of claim 9, the first one-way locking member further comprising:
an enlarged head disposed on the second end of the first flexible member;
a channel defined by the head and extending therethrough; and
wherein the first end passes through the channel to permanently lock the first flexible member therein.

11. The anti-theft security device of claim 10, further comprising:
a gear rack disposed on the first flexible member;
a ratchet proximate the channel; and
wherein the gear rack abuts the ratchet to permanently lock the first flexible member to the housing.

12. The anti-theft security device of claim 11, wherein the housing includes a bottom surface, and wherein at least one fin extends outwardly away from the bottom surface.

13. The anti-theft security device of claim 12, wherein the bottom surface is accurate.

14. The anti-theft security device of claim 12, further comprising:
a second flexible member extending from the housing and terminating in a second end, wherein the second flexible member is adapted to encircle a second portion of the article; and
a second one-way locking member disposed in the housing and configured to receive the second end of the second flexible member to permanently lock the second flexible member to the housing.

15. A disposable anti-theft security device adapted to be secured to an article of goods, said security device comprising:
a first clamping member;
a second clamping member connected to the first clamping member;
a security tag disposed in one of the first clamping member and the second clamping member;
a one-way locking member configured to permanently lock the first clamping member to the second clamping member when the article is clamped therebetween; and
wherein at least one of the first clamping member and second clamping member is manually movable to clamp the article therebetween.

16. The disposable anti-theft security device of claim 15, wherein the first clamping member is a housing, and the second clamping member is one of a length of cable and a cable tie fastener device.

17. The disposable anti-theft security device of claim 15, wherein the first clamping member is a housing defining a button aperture and the second clamping member is a button sized to reside in the button aperture, and wherein the button is manually movable within the button aperture.

18. A method of protecting an article of goods including the steps of:
attaching an anti-theft security device to the article;
selling the article with the anti-theft security device attached to a purchaser; and
permitting the anti-theft security device to remain on the article for subsequent disposal by the purchaser.

19. The method of claim 18, including the steps of:
disposing the article in a packaging; and
selling the article in the packaging with the anti-theft security device attached.

20. The method of claim 18, including the steps of:
providing the security device to a manufacturer of the article; and
allowing the manufacturer to attach the security device to the article.

21. The method of claim 18, including the steps of:
providing a housing defining an internal chamber on the security device;
providing a security tag disposed in the internal chamber on the security device;
providing a first flexible member on the security device and extending from the housing and terminating in a first end, wherein the first flexible member is adapted to encircle a first portion of the article; and
providing a first one-way locking member on the security device and disposed in the housing and configured to receive the first end of the first flexible member to permanently lock the first flexible member to the housing.

22. The method of claim 21, including the step of forming the first flexible member from one of a length of cable or a cable tie fastener device.
